SEQUENCE LISTING (36 sequences)

SEQ ID NO: 1 - protein, 182 aa, Bacillus cibi
TPPGTPSKSAAQYQLNALTVKPEGSMLGYSRDKFPHWIPQGGGCDTRQVVLKRDAISYVGNCPVVSGSWYSYYDGLTFTNPSDLDIDHIVPLAEAWRSGASSWTTSKRRDFANDLDGPQLIAVSASVNRSKGDQDPSTWQPPRPGAACGYSKWWISTKYKWGLSLQLSEKTALQDMLNSCSY

SEQ ID NO: 2 - protein, 583 aa, Bacillus sp.
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAKTSNVTFTVNNATTTSGQNVYVVANIPELGNWNTANAIKMNPSSYPTWKATIALPQGKAIEFKFIKKDQAGNVIWESTSNRTYTVPFSSTGSYTASWNVP

SEQ ID NO: 3 - protein, 485 aa, Cytophaga sp.
AATNGTMMQYFEWYVPNDGQQWNRLRTDAPYLSSVGITAVWTPPAYKGTSQADVGYGPYDLYDLGEFNQKGTVRTKYGTKGELKSAVNTLHSNGIQVYGDVVMNHKAGADYTENVTAVEVNPSNRNQETSGEYNIQAWTGFNFPGRGTTYSNFKWQWFHFDGTDWDQSRSLSRIFKFRGTGKAWDWEVSSENGNYDYLMYADIDYDHPDVVNEMKKWGVWYANEVGLDGYRLDAVKHIKFSFLKDWVDNARAATGKEMFTVGEYWQNDLGALNNYLAKVNYNQSLFDAPLHYNFYAASTGGGYYDMRNILNNTLVASNPTKAVTLVENHDTQPGQSLESTVQPWFKPLAYAFILTRSGGYPSVFYGDMYGTKGTTTREIPALKSKIEPLLKARKDYAYGTQRDYIDNPDVIGWTREGDSTKAKSGLATVITDGPGGSKRMYVGTSNAGEIWYDLTGNRTDKITIGSDGYATFPVNGGSVSVWVQQ

SEQ ID NO: 4 - protein, 485 aa, Bacillus sp.
HHNGTNGTMMQYFEWYLPNDGNHWNRLRSDASNLKDKGITAVWIPPAWKGASQNDVGYGAYDLYDLGEFNQKGTVRTKYGTRNQLQAAVTALKSNGIQVYGDVVMNHKGGADATEWVRAVEVNPSNRNQEVSGDYTIEAWTKFDFPGRGNTHSNFKWRWYHFDGVDWDQSRQLQNRIYKFRGDGKGWDWEVDTENGNYDYLMYADIDMDHPEVVNELRNWGVWYTNTLGLDGFRIDAVKHIKYSFTRDWLTHVRNTTGKNMFAVAEFWKNDIGAIENYLSKTNWNHSVFDVPLHYNLYNASRSGGNYDMRQIFNGTVVQRHPTHAVTFVDNHDSQPEEALESFVEEWFKPLACALTLTRDQGYPSVFYGDYYGIPTHGVPAMKSKIDPILEARQKYAYGKQNDYLDHHNMIGWTREGNTAHPNSGLATIMSDGPGGNKWMYVGRNKAGQVWRDITGNRSGTVTINADGWGNFSVNGGSVSIWVNN

SEQ ID NO: 5 - protein, 485 aa, Bacillus sp.
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVKR

SEQ ID NO: 6 - protein, 485 aa, Bacillus subtilis
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK

SEQ ID NO: 7 - protein, 485 aa, Bacillus sp.
HHDGTNGTIMQYFEWNVPNDGQHWNRLHNNAQNLKNAGITAIWIPPAWKGTSQNDVGYGAYDLYDLGEFNQKGTVRTKYGTKAELERAIRSLKANGIQVYGDVVMNHKGGADFTERVQAVEVNPQNRNQEVSGTYQIEAWTGFNFPGRGNQHSSFKWRWYHFDGTDWDQSRQLANRIYKFRGDGKAWDWEVDTENGNYDYLMYADVDMDHPEVINELNRWGVWYANTLNLDGFRLDAVKHIKFSFMRDWLGHVRGQTGKNLFAVAEYWKNDLGALENYLSKTNWTMSAFDVPLHYNLYQASNSSGNYDMRNLLNGTLVQRHPSHAVTFVDNHDTQPGEALESFVQGWFKPLAYATILTREQGYPQVFYGDYYGIPSDGVPSYRQQIDPLLKARQQYAYGRQHDYFDHWDVIGWTREGNASHPNSGLATIMSDGPGGSKWMYVGRQKAGEVWHDMTGNRSGTVTINQDGWGHFFVNGGSVSVWVKR

SEQ ID NO: 8 - protein, 485 aa, Bacillus sp.
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGPQHDYIDHPDVIGWTREGDSSAAKSGLAALITDGPGGSKRMYAGLKNAGETWYDITGNRSDTVKIGSDGWGEFHVNDGSVSIYVQK

SEQ ID NO: 9 - protein, 485 aa, Artificial
  Artificial
HHDGTNGTIMQYFEWNVPNDGQHWNRLHNNAQNLKNAGITAIWIPPAWKGTSQNDVGYGAYDLYDLGEFNQKGTVRTKYGTKAELERAIRSLKANGIQVYGDVVMNHKGGADFTERVQAVEVNPQNRNQEVSGTYQIEAWTGFNFPGRGNQHSSFKWRWYHFDGTDWDQSRQLANRIYKFRGDGKAWDWEVDTENGNYDYLMYADVDMDHPEVINELNRWGVWYANTLNLDGFRLDAVKHIKFSFMRDWLGHVRGQTGKNLFAVAEYWKNDLGALENYLSKTNWTMSAFDVPLHYNLYQASNSSGNYDMRNLLNGTLVQRHPSHAVTFVDNHDTQPGEALESFVQGWFKPLAYATILTREQGYPQVFYGDYYGIPSDGVPSYRQQIDPLLKARQQYAYGTQHDYLDNQDVIGWTREGDSAHAGSGLATVMSDGPGGSKTMYVGTAHAGQVFKDITGNRTDTVTINSAGNGTFPCNGGSVSIWVKQ

SEQ ID NO: 10 - protein, 773 aa, Bacillus sp.
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 11 - protein, 415 aa, Humicola insolens
QKPGETKEVHPQLTTFRCTKRGGCKPATNFIVLDSLSHPIHRAEGLGPGGCGDWGNPPPKDVCPDVESCAKNCIMEGIPDYSQYGVTTNGTSLRLQHILPDGRVPSPRVYLLDKTKRRYEMLHLTGFEFTFDVDATKLPCGMNSALYLSEMHPTGAKSKYNPGGAYYGTGYCDAQCFVTPFINGLGNIEGKGSCCNEMDIWEANSRASHVAPHTCNKKGLYLCEGEECAFEGVCDKNGCGWNNYRVNVTDYYGRGEEFKVNTLKPFTVVTQFLANRRGKLEKIHRFYVQDGKVIESFYTNKEGVPYTNMIDDEFCEATGSRKYMELGATQGMGEALTRGMVLAMSIWWDQGGNMEWLDHGEAGPCAKGEGAPSNIVQVEPFPEVTYTNLRWGEIGSTYQEVQKPKPKPGHGPRSD

SEQ ID NO: 12 - protein, 284 aa, Humicola insolens
ADGRSTRYWDCCKPSCGWAKKAPVNQPVFSCNANFQRITDFDAKSGCEPGGVAYSCADQTPWAVNDDFALGFAATSIAGSNEAGWCCACYELTFTSGPVAGKKMVVQSTSTGGDLGSNHFDLNIPGGGVGIFDGCTPQFGGLPGQRYGGISSRNECDRFPDALKPGCYWRFDWFKNADNPSFSFRQVQCPAELVARTGCRRNDDGNFPAVQIPSSSTSSPVNQPTSTSTTSTSTTSSPPVQPTTPSGCTAERWAQCGGNGWSGCTTCVAGSTCTKINDWYHQCL

SEQ ID NO: 13 - protein, 278 aa, Thielavia terrestris [sequence omitted]

SEQ ID NO: 14 - protein, 269 aa, Thermomyces lanuginosus [sequence omitted]

SEQ ID NO: 15 - protein, 299 aa, Bacillus bogoriensis
ANSGFYVSGTTLYDANGNPFVMRGINHGHAWYKDQATTAIEGIANTGANTVRIVLSDGGQWTKDDIHTVRNLISLAEDNHLVAVLEVHDATGYDSIASLNRAVDYWIEMRSALIGKEDTVIINIANEWFGSWEGDAWADGYKQAIPRLRNAGLNHTLMVDAAGWGQFPQSIHDYGREVFNADPQRNTMFSIHMYEYAGGNASQVRTNIDRVLNQDLALVIGEFGHRHTNGDVDEATIMSYSEQRGVGWLAWSWKGNGPEWEYLDLSNDWAGNNLTAWGNTIVNGPYGLRETSRLSTVFQ

SEQ ID NO: 16 - protein, 330 aa, Paenibacillus woosongensis
IRTGTLNNPEATAEARALMNYLLSQYGQKIISGQQTLEDVEWIKQQTGKYPAIFSTDLMDYSPSRVDHGASSTEVEKMIEWYKRGGIVSLCWHWNAPKGIGGNEPGNEWWRGFYTEFTTFDVEYALNHPDSEDYQLLIRDIDAIAVQLKRLQEANVPVLWRPLHEAEGTWFWWGAKGPEPAKQLYRLMYDRLTNDHKLNNLIWVWNSEKKDWYPGDDVVDMVSVDIYNPAGDYNPSIAKYEALVSLADNKKMAALAENGPIPDPDALQEYGADWSFFSTWTGDYIRDGKTNTIEHLKKVYQHDYVITLDELPADCTPILMIRQRMVNQQG

SEQ ID NO: 17 - protein, 312 aa, Paenibacillus illinoisensis
ASPQAKALMKFMTNQYGKKIISGQQTLEDAAWIYQQTGKYPALVSSDLMDYSPSRVENGSTSNEVEKMMEWYKRGGIVSLSWHWNAPKGIGSNEPGHEWWRGFNTEFTTFDVEYALNHPESEDYKLLIRDIDAIATQLKRLQEHHIPVLWRPLHEAEGGWFWWGAKGPEPAKKLYRLMYERLTEKHGLNNLIWVWNSVKEEWYPGDDVVDMVSVDIYNPPGDYSPNIAKYDELLFLSKHKKLVALAENGPIPDPDLLQTYGAHWSYFNTWTGDVLRDGKTNTKEHLKKVYNHDNVITLDELPKGLYDSPRWK

SEQ ID NO: 18 - protein, 699 aa, Neobulgaria sp.
TVFEAEKGTLAGGLTIATDVTGYTGTGYVTNFADAAALLTFTVNGLTAGSYDLTLTYSAQYGDKFTTVSVNGASGIEVAITNVTTATWTTATIGTFTLTAGDNTVSCADDWGWYLIDSLTVIPTPAKPITIVDVSNGATAQAEDGILTGTTVGTTTAGYTGTGYVTGFTATGTQVTINLSSTKQALYDVVVRYAAIYGQKYTTMQLNGVGGSEILLLDTTTATSPWANATAGQVLLASGNNTLTFMNDWGWYFIDAVYVTPSPAPAPHKVTNALVDAKALASTHALFNTLLAKYGSGDIFSGQADPTGVTWIESNLGTTKTPAIIGLDMIEYSPTRVLYGSTSTAVEDAIAFDKRGGMVAFQWHWNAPADLINNDTVPWWKGFYSYGTTFNLTAALANPSGSDYALLISDMDAIAVQLLRLQAAGVPVLWRPLHEADGTWFWWGNFGAASCVSLYRIMYDRYTNYHGLHNLIWVWNSVTPSWYPGADVVDILGYDSYPAVGDHGPVSSQYNALITLGGDTKLVTLPEVGNIPDPAILKLYHADWSYFVTWNQDYILTDTYNPLAFKQQVYNDPTVLKLTDLGNWKGAATSTIVSSTSKVSTTTSSLITSTTKKTSSSTVVSTTSSTVKTTSTTSKVSSSTTKVSSTTKVTTTSTTTSAVATATAGHWGQCGGTGWTGPTVCASGFTCTAVSPPYYYQCL

SEQ ID NO: 19 - protein, 452 aa, Preussia aemulans
QTVIYQAEQAKLSGVTVEFSIIKQVVGTGYVEGFDESTDSITFTVESTTAALYDLALTYNGPYGDKYTNVVLNNAAGSQVSLPATTAWTTVPAGQVLLNAGANTIQIQNNWGWYLVDSISLKPAATRGAHQITTKPVNKNANSDAKALLKYLGSIYGKKILSGQQDLSSLDWVTKNVGKTPAVLGLDTMDYSESRKSRGAVSTDVDKAIAFAKKGGIVTFCWHWGAPTGLFDSAAQPWYRGFYTDATDFNIETALKDTTNANYTLLMKDIDTIAVQLKKLQDAGVPVIWRPLHEAEGGWFWWGAKGPEPAKKLWKIMYDRLTNQHGLNNLVWTWNSVAPNWYPGDDTVDIVSADTYSQGDHGPISATYNNLLALTNDTKIIAAAEIGSVMEPAQLQAYQADWVYFCVWSGEFIDGGVWNSLDFLKKVYNDPYVLTLDEIQGWKTARGKPRVS

SEQ ID NO: 20 - protein, 312 aa, Yunnania penicillata
APSTTPVNEKATDAAKNLLSYLVEQAANGVTLSGQQDLESAQWVSDNVGKWPAILGIDFMDYSPSRVEYGAVGSTVPDAISYDSDGGIVTFCWHWGSPSGTYNTTDQPWWSNFYTEATAFDIAAAMDDPDSADYNLLVRDIDAISELLLQLQDLDIPILWRPLHEAEGGWFWWGAKGPEACIALYRLMFDRMTNHHGLNNLLWVWNSVDPSWYPGNDVVDIVSADIYADAGDHSPQEETFASLQSLTGDTKLVALGEVGNIPDPASTGGVADWAYWVTWNGDFIKGEDYNPLEYKKEVFSAENIITRDEVDV

SEQ ID NO: 21 - protein, 327 aa, Myrothecium roridum
GTIENRQWLTYNPVDSAATTEARALLRYIQSQYGWRYLSGQQERAEVQWLKSNIGKTPAIQGSDLIDYSPSRVSYGATSTAVEDAIAFDRQGGIVTFTWHWNAPNCLYNSADQPWYFGFYTKATCFNIQAALAQGSNGADYKLLIRDIDAIAVQLKRLRDAKVPILFRPLHEPDGAWFWWGAKGSGPFKQLWDILYDRLTKYHGLHNMLWVCNTEKSDWYPGNNKCDIATTDVYVNAGDHSVQKSHWDALYGVSGGQRILALGEVGVIPDPERQASENVPWAYWMTWNGYFIRDGNYNSRNFLQSTFSNARVVTLDGTSPLGNWKSS

SEQ ID NO: 22 - protein, 452 aa, Chaetomium brasiliense
VPCGGGSNSGPRTYEAEDADLTGTNIDTAQSGFTGSGYVTGFDQATDKVTFKVDSPSLKLYDLSIRVAAIYGEKRTNVVLNNGASSEVYFAASETFTTVAAGQVLLNEGANTIDLVSNWGWYLIDSITLTPSTQRPPHNINPSPVNPSANADAKGLYTYLRSIYGKKILSGQQELSWSNWITTQTGKTPALVSVDLMDYSPSRVERGTVGTAVEEAITHAQRGGIVSVLWHWNAPTGLYDTEENKWWSGFYTRATDFDVAAALSSTTNANYTLILRDIDAIAVQLKKLQDAGVPVLFRPLHEAEGGWFWWGAKGAEPCKKLYALLYDRLTNYHKINNLIWVWNSILEEWYPGDATVDILSADVYAQGNGPISTQYNQLIELGKDKKMIAAAEVGAAPLPNLLQAYEAHWLWFTVWGDTFINNAEWNSVDVLKQVYTSDYVLTLDEIQGWRGA

SEQ ID NO: 23 - protein, 541 aa, Ascobolus stictoideus
QTYTLEAEAGTLTGVTVMNEIAGFSGTGYVGGWDEDADTVSLTFTSDATKLYDVKIRYSGPYGSKYTRISYNGATGGDISLPETTEWATVNAGQALLNAGSNTIKLHNNWGWYLIDAVILTPSVPRPPHQVTDALVNTNSNAVTKQLMKFLVSKYHKAYITGQQELHAHQWVEKNVGKSPAILGLDFMDYSPSRVEFGTTSQAVEQAIDFDKRGGIVTFAWHWNAPSGLINTPGSEWWRGFYTEHTTFDVAAALQNTTNANYNLLIRDIDAIAVQLKRLQTAGVPVLWRPLHEAEGGWFWWGAKGPEPAKKLYKILYDRLTNYHKLNNLIWVWNSVAKDWYPGDEIVDVLSFDSYPAQPGDHGPVSAQYNALVELGKDKKLIAATEVGTIPDPDLMQLYESYWSFFVTWEGEFIENGVHNSLEFLKKLYNNSFVLNLDTIQGWKNGAGSSTTTVKSTTTTPTTTIKSTTTTPVTTPTTVKTTTTPTTTATTVKSTTTTAGPTPTAVAGRWQQCGGIGFTGPTTCEAGTTCNVLNPYYSQCL

SEQ ID NO: 24 - protein, 526 aa, Chaetomium virescens
PRDPGATARTFEAEDATLAGTNVDTALSGFTGTGYVTGFDQAADKVTFTVDSASTELYDLSIRVAAIYGDKRTSVVLNGGASSEVYFPAGETWTNVAAGQLLLNQGSNTIDIVSNWGWYLIDSITLTPSTPRPAHQINEAPVNAAADKNAKALYSYLRSIYGKKILSGQQELSLSNWIAQQTGKTPALVSVDLMDYSPSRVERGTVGTAVEEAIQHHNRGGIVSVLWHWNAPTGLYDTEEHRWWSGFYTSATDFDVAAALSSTTNANYTLLIRDIDAIAVQLKRLQSAGVPVLFRPLHEAEGGWFWWGAKGPEPAKKLWGILYDRVTNHHQINNLLWVWNSILPEWYPGDATVDILSADVYAQGNGPMSTQYNQLIELGKDKKMIAAAEVGAAPLPDLLQAYEAHWLWFTVWGDSFINNADWNSLDTLKKVYTSDYVLTLDEIQGWQGSTPSATTTSSTTTPSATTTTTTPSTTATTATPSATTTASPVTYAEHWGQCAGKGWTGPTTCRPPYTCKYQNDWYSQCL

SEQ ID NO: 25 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 26 - protein, 275 aa, Bacillus amyloliquefaciens [sequence omitted]

SEQ ID NO: 27 - protein, 311 aa, Bacillus sp. [sequence omitted]

SEQ ID NO: 28 - protein, 269 aa, Bacillus gibsonii
QQTVPWGITRVQAPAVHNRGVTGSGVRVAILDSGISTHSDLTIRGGASFVPGEPTTADLNGHGTHVAGTVAALNNSIGVIGVAPSADLYAVKVLGANGRGSVSGIAQGLEWAAANNMHIANMSLGSDAPSITLERAVNYATSQGVLVIAATGNNGSGSVGYPARYANAMAVGATDQNNRRANFSQYGTGIDIVAPGVNVQSTYPGNRYASLNGTSMATPHVAGAAALVKQRYPSWNATQIRNHLKNTATNLGNSSQFGSGLVNAEAATR

SEQ ID NO: 29 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 30 - protein, 274 aa, Bacillus licheniformis
AQTVPYGIPLIKADKVQAQGFKGANVKVAVLDTGIQASHPDLNVVGGASFVAGEAYNTDGNGHGTHVAGTVAALDNTTGVLGVAPSVSLYAVKVLNSSGSGSYSGIVSGIEWATTNGMDVINMSLGGASGSTAMKQAVDNAYARGVVVVAAAGNSGSSGNTNTIGYPAKYDSVIAVGAVDSNSNRASFSSVGAELEVMAPGAGVYSTYPTNTYATLNGTSMASPHVAGAAALILSKHPNLSASQVRNRLSSTATYLGSSFYYGKGLINVEAAAQ

SEQ ID NO: 31 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQAECEKPGAVVTSFHDQSLKLGTYSLVTLPMAGYVAADGNGSVQESEAAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 32 - protein, 214 aa, Melanocarpus albomyces
ANGQSTRYWDCCKPSCGWRGKGPVNQPVYSCDANFQRIHDFDAVSGCEGGPAFSCADHSPWAINDNLSYGFAATALSGQTEESWCCACYALTFTSGPVAGKTMVVQSTSTGGDLGSNHFDLNIPGGGVGLFDGCTPQFGGLPGARYGGISSRQECDSFPEPLKPGCQWRFDWFQNADNPSFTFERVQCPEELVARTGCRRHDDGGFAVFKAPSA

SEQ ID NO: 33 - protein, 297 aa, Paenibacillus species
MATGFYVSGNKLYDSTGKPFVMRGVNHGHSWFKNDLNTAIPAIAKTGANTVRIVLSNGSLYTKDDLNAVKNIINVVNQNKMIAVLEVHDATGKDDYNSLDAAVNYWISIKEALIGKEDRVIVNIANEWYGTWNGSAWADGYKKAIPKLRNAGIKNTLIVDAAGWGQFPQSIVDYGQSVFAADSQKNTVFSIHMYEYAGKDAATVKANMENVLNKGLALIIGEFGGYHTNGDVDEYAIMRYGQEKGVGWLAWSWYGNSSGLNYLDMATGPNGSLTSFGNTVVNDTYGIKNTSQKAGIF

SEQ ID NO: 34 - protein, 464 aa, Bacillus hemicellulosilyticus
QTHSGFYIEGSTLYDANGEPFVMRGINHGHAWYKHDSNVAIPAIANQGANTIRIVLSDGGQWAKDDINTLNQVLDLAEEHEMIAVVEVHDATGSNSMADLNRAVDYWIEMKDALIGKEDRVIINIANEWYGAWDGQGWANGYKEVIPRLRNAGFTHTLMVDAAGWGQYPQSIHDYGQEVFNADPLANTMFSIHMYEYAGGNASMVQSNIDGVVDQGLALVIGEFGHMHTDGDVDEATILSYSQQRGVGWLAWSWKGNGTQWEYLDLSYDWQGTNLTSWGNTIVHGPNGLLETSIPSSIFHTAPNNGDPPPHNGNETILYDFEHGTQGWSGSSLLGGPWTTNEWSTNGNHSLKADIFLSANSKHELAKVENRNLSGYSTLQATVRHAHWGNVGNLTARMYVKTGSNYSWFNGDPIPVNSANGTTVTLPLSSIPNLNDVKEIGVEFIGASNSNGQTAIYLDHVTIQ

SEQ ID NO: 35 - protein, 484 aa, Bacillus sp.
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAK

SEQ ID NO: 36 - protein, 182 aa, Bacillus cibi [sequence omitted]

(19) United States
(12) Patent Application Publication
(10) Pub. No.: US 2022/0333039 A1
(43) Pub. Date: Oct. 20, 2022

(54) COMPOSITIONS COMPRISING ENZYMES

(71) Applicant: The Procter & Gamble Company, Cincinnati, OH (US)

(72) Inventors: Neil Joseph LANT, Newcastle upon Tyne (GB); Klaus Gori, Dyssegaard (DK)

(21) Appl. No.: 17/846,696

(22) Filed: Jun. 22, 2022

Related U.S. Application Data
(63) Continuation of application No. PCT/US2020/066287, filed on Dec. 21, 2020.

(30) Foreign Application Priority Data
Dec. 23, 2019 (EP) 19219568.3

(51) Int. Cl. C11D 3/386

(52) U.S. Cl. CPC C11D 3/38609; C11D 3/38618; C11D 3/38645; C11D 3/38636

(57) ABSTRACT

A cleaning composition comprising deoxyribonuclease enzymes, an additional enzyme and a cleaning adjunct, methods of making such cleaning compositions and methods of treating surfaces such as fabrics or hard surfaces with aqueous liquor comprising such compositions.

### REFERENCE TO A SEQUENCE LISTING This application contains a Sequence Listing in computer readable form. The computer readable form is incorporated herein by reference.

### FIELD OF THE INVENTION

The present invention relates to cleaning compositions comprising a mixture of enzymes, methods of making them and methods of using them. The compositions and methods of the invention are suitable for use in household cleaning or treatment compositions, in particular laundry cleaning and hard surface cleaning. The invention is particularly useful for cleaning laundry.

### BACKGROUND OF THE INVENTION

Enzymes have been known for use in household cleaning compositions for many years. Usually a mixture of enzymes is used in which each enzyme is selected to target a specific substrate. Fabric surfaces and hard surfaces, such as dishes, floors, showers, internal surfaces of dishwashing or laundry washing machines, etc, become soiled with complex soils, which may comprise one or more of proteins, oily soils, starch and/or other polysaccharides and extracellular DNA (exDNA). Additionally, organic stains such as biofilms may cause malodor issues as malodor molecules may be adhered by the polysaccharides, extracellular DNA (exDNA), and proteins in the complex extracellular matrix. These complex soils are difficult to remove and may also lead to fabric greying because they may attract other soils such as particulate soils which results in further soiling and fabric greying. Thus, there is still a need for cleaning compositions which provide good cleaning, preventing or reducing the problems above.

### SUMMARY OF THE INVENTION

The present invention relates to a cleaning composition comprising a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1; at least one additional enzyme selected from the group consisting of mannanases, amylases, cellulases, lipases, proteases and mixtures thereof, preferably comprising a mannanase, most preferably a mannanase having at least 60%, at least 65%, at least 70%, at least 75%, at least 80%, at least 85%, at least 90%, at least 95%, at least 98% or 100% sequence identity to SEQ ID NO: 15; and a cleaning adjunct, the cleaning adjunct preferably comprising a surfactant. The present invention also provides a cleaning composition comprising: a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1; at least one additional enzyme selected from the group consisting of mannanases, amylases, cellulases, lipases, proteases and mixtures thereof, preferably comprising a mannanase, most preferably a mannanase having at least 60%, at least 65%, at least 70%, at least 75%, at least 80%, at least 85%, at least 90%, at least 95%, at least 98% or 100% sequence identity to SEQ ID NO: 15; and a cleaning adjunct preferably comprising a surfactant, with the proviso that the DNase is not the DNase shown in SEQ ID NO: 36.

The present invention also provides a method of making a cleaning composition comprising: obtaining a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1, optionally with the proviso that the DNase is not the DNase shown in SEQ ID NO: 36; at least one additional enzyme selected from the group consisting of mannanases, amylases, cellulases, lipases, proteases and mixtures thereof; and a cleaning adjunct, preferably comprising a surfactant, and mixing to make a cleaning composition.

The invention also provides a method of treating a surface, preferably a fabric, comprising

(i) forming an aqueous wash liquor comprising water, a DNase as described herein; at least one additional enzyme selected from the group consisting of mannanases, amylases, cellulases, lipases, proteases and mixtures thereof; and a cleaning adjunct, preferably comprising a surfactant;

(ii) treating the surface with the aqueous wash liquor preferably at a temperature of from 5 to 60° C., preferably from 10 to 40° C., or preferably up to 35° C., more preferably at a temperature of 30° C. or less, or at a temperature of 20° C. or less; and optionally

(iii) rinsing the surface.

The present invention also provides use of a composition as described herein for cleaning e.g. deep cleaning of an item, wherein the item is a textile or a surface.

The present invention also provides a kit intended for cleaning e.g. deep cleaning, wherein the kit comprises a solution or particle comprising one or more of (i) a DNase as described herein; (ii) additional enzyme as described herein; and (iii) a cleaning adjunct as described herein, for mixing with water to form an aqueous wash liquor for cleaning surfaces.

The compositions, method and kit herein are particularly useful for treating a fabric surface comprising cotton and/or synthetic fibres such as polyester, nylon, etc, which may be in the form of fibres or fabric, for example single or mixed fabric, such as polycotton. The compositions or methods described herein are also particularly useful for treating hard surfaces, for example, floors, walls, and/or surfaces in bathrooms and kitchens.

### DETAILED DESCRIPTION OF THE INVENTION

### Overview of Sequences

SEQ ID NO: 1 polypeptide obtained from Bacillus cibi
SEQ ID NO: 2 polypeptide obtained from Bacillus sp.
SEQ ID NO: 3 polypeptide obtained from Cytophaga sp.
SEQ ID NO: 4 polypeptide obtained from Bacillus sp.
SEQ ID NO: 5 polypeptide obtained from Bacillus sp.
SEQ ID NO: 6 polypeptide obtained from Bacillus subtilis
SEQ ID NO: 7 polypeptide obtained from Bacillus sp.
SEQ ID NO: 8 polypeptide obtained from Bacillus sp.
SEQ ID NO: 9 Artificial sequence
SEQ ID NO: 10 polypeptide obtained from Bacillus sp.
SEQ ID NO: 11 polypeptide obtained from Humicola insolens
SEQ ID NO: 12 polypeptide obtained from Humicola insolens
SEQ ID NO: 13 polypeptide obtained from Thielavia terrestris
SEQ ID NO: 14 polypeptide obtained from Thermomyces lanuginosus
SEQ ID NO: 15 polypeptide obtained from Bacillus bogoriensis
SEQ ID NO: 16 polypeptide obtained from Paenibacillus woosongensis
SEQ ID NO: 17 polypeptide obtained from Paenibacillus illinoisensis
SEQ ID NO: 18 polypeptide obtained from Neobulgaria sp.
SEQ ID NO: 19 polypeptide obtained from Preussia aemulans
SEQ ID NO: 20 polypeptide obtained from Yunnania penicillata
SEQ ID NO: 21 polypeptide obtained from Myrothecium roridum
SEQ ID NO: 22 polypeptide obtained from Chaetomium brasiliense
SEQ ID NO: 23 polypeptide obtained from Ascobolus stictoideus
SEQ ID NO: 24 polypeptide obtained from Chaetomium virescens
SEQ ID NO: 25 polypeptide obtained from Bacillus lentus
SEQ ID NO: 26 polypeptide obtained from Bacillus amyloliquefaciens
SEQ ID NO: 27 polypeptide obtained from Bacillus sp.
SEQ ID NO: 28 polypeptide obtained from Bacillus gibsonii
SEQ ID NO: 29 polypeptide obtained from Bacillus lentus
SEQ ID NO: 30 polypeptide obtained from Bacillus licheniformis
SEQ ID NO: 31 polypeptide obtained from Paenibacillus polymyxa
SEQ ID NO: 32 polypeptide obtained from Melanocarpus albomyces
SEQ ID NO: 33 polypeptide obtained from Paenibacillus species
SEQ ID NO: 34 polypeptide obtained from Bacillus hemicellulosilyticus
SEQ ID NO: 35 polypeptide obtained from Bacillus sp.
SEQ ID NO: 36 polypeptide obtained from Bacillus cibi

### Definitions

In accordance with this detailed description, the following definitions apply. Note that the singular forms “a,” “an,” and “the” include plural references unless the context clearly dictates otherwise.

Reference to “about” a value or parameter herein includes aspects that are directed to that value or parameter per se. For example, description referring to “about X” includes the aspect “X”.

Unless defined otherwise or clearly indicated by context, all technical and scientific terms used herein have the same meaning as commonly understood by one of ordinary skill in the art to which this invention belongs.

Amino Acid: The term “amino acid” as used herein includes the standard twenty genetically-encoded amino acids and their corresponding stereoisomers in the form (as compared to the natural ‘1’ form), omega-amino acids other naturally-occurring amino acids, unconventional amino acids (e.g. α, α-disubstituted amino acids, N-alkyl amino acids, etc.) and chemically derivatised amino acids. Chemical derivatives of one or more amino acids may be achieved by reaction with a functional side group. Such derivatised molecules include, for example, those molecules in which free amino groups have been derivatised to form amine hydrochlorides, p-toluene sulphonyl groups, carboxybenzoxy groups, t-butyloxycarbonyl groups, chloroacetyl groups or formyl groups. Free carboxyl groups may be derivatised to form salts, methyl and ethyl esters or other types of esters and hydrazides. Free hydroxyl groups may be derivatised to form 0-acyl or 0-alkyl derivatives. Also included as chemical derivatives are those peptides which contain naturally occurring amino acid derivatives of the twenty standard amino acids. For example: 4-hydroxyproline may be substituted for proline; 5-hydroxylysine may be substituted for lysine; 3-methylhistidine may be substituted for histidine; homoserine may be substituted for serine and ornithine for lysine. Derivatives also include peptides containing one or more additions or deletions as long as the requisite activity is maintained. Other included modifications are amidation, amino terminal acylation (e.g. acetylation or thioglycolic acid amidation), terminal carboxylamidation (e.g. with ammonia or methylamine), and the like terminal modifications.

When an amino acid is being specifically enumerated, such as ‘alanine’ or ‘Ala’ or ‘A’, the term refers to both 1-alanine and d-alanine unless explicitly stated otherwise. Other unconventional amino acids may also be suitable components for polypeptides of the present invention, as long as the desired functional property is retained by the polypeptide. For the peptides shown, each encoded amino acid residue, where appropriate, is represented by a single letter designation, corresponding to the trivial name of the conventional amino acid. In one embodiment, the polypeptides of the invention comprise or consist of 1-amino acids.

Amylases: Amylases (EC 3.2.1) are enzymes which catalyze the hydrolysis of starch, glycogen, and related polysaccharides to oligosaccharides, maltose, or glucose. Amylases are glycoside hydrolases and act on a-1,4-glycosidic bonds. The amylases suitable in the cleaning compositions of the invention are preferably alpha amylases. α-amylases (EC 3.2.1.1) includes 1,4-α-D-glucan glucanohydrolase and glycogenase and are calcium metalloenzymes. By acting at random locations along the starch chain, α-amylase breaks down long-chain carbohydrates, ultimately yielding maltotriose and maltose from amylose, or maltose, glucose and “limit dextrin” from amylopectin. Suitable amylases of the present invention are preferably microbial e.g. obtained from bacterial or fungal sources. The term “alpha-amylase activity” means the activity of alpha 1,4-glucan 4 glucanohydrolases, E.C. 3.2.1.1, which constitute a group of enzymes, which catalyze hydrolysis of starch and other linear and branched 1,4 alpha-glucosidic oligo and poly-saccharides. Alpha-amylase activity may be determined by Assay III as described in the Examples herein.

The terms “alpha-amylase” and “amylase” may be used interchangeably and constitute the same meaning and purpose herein.

Biofilm: The term “biofilm” means sticky soil typically produced by microorganisms which comprises a matrix of extracellular polymeric substance (EPS). Biofilm may comprise microbial cells, which are also stick to one another. Biofilm EPS is a polymeric conglomeration generally composed of extracellular DNA, proteins, and polysaccharides. Biofilms may form on living or non-living surfaces. The microbial cells which may grow in a biofilm are physiologically distinct from planktonic cells of the same organism, which, by contrast, are single-cells that may float or swim in a liquid medium. Bacteria which may live in a biofilm usually have significantly different properties from planktonic bacteria of the same species, as the dense and protected environment of the film allows them to cooperate and interact in various ways. One benefit of this environment for the microorganisms is increased resistance to detergents and antibiotics, as the dense extracellular matrix and the outer layer of cells protect the interior of the community. In the context of laundry, examples of biofilm-producing bacteria are the following species: Acinetobacter sp., Aeromicrobium sp., Brevundimonas sp., Microbacterium sp., Micrococcus luteus, Pseudomonas sp., Staphylococcus epidermidis, and Stenotrophomonas sp. On hard surfaces examples of biofilm-producing bacteria are the following species: Acinetobacter sp., Aeromicrobium sp., Brevundimonas sp., Microbacterium sp., Micrococcus luteus, Pseudomonas sp., Staphylococcus epidermidis, Staphylococcus aureus and Stenotrophomonas sp.

Catalytic domain: The term “catalytic domain” means the region of an enzyme containing the catalytic machinery of the enzyme.

cDNA: The term “cDNA” means a DNA molecule that can be prepared by reverse transcription from a mature, spliced, mRNA molecule obtained from a eukaryotic cell. cDNA lacks intron sequences that may be present in the corresponding genomic DNA. The initial, primary RNA transcript is a precursor to mRNA that is processed through a series of steps, including splicing, before appearing as mature spliced mRNA.

Cellulolytic enzyme or cellulase: The term “cellulolytic enzyme” or “cellulase” means one or more enzymes that hydrolyze a cellulosic material. Such enzymes include endoglucanase(s), cellobiohydrolase(s), beta-glucosidase(s), or combinations thereof. The two basic approaches for measuring cellulolytic activity include: (1) measuring the total cellulolytic activity, and (2) measuring the individual cellulolytic activities (endoglucanases, cellobiohydrolases, and beta-glucosidases) as reviewed in Zhang et al., Outlook for cellulase improvement: Screening and selection strategies, 2006, Biotechnology Advances 24: 452-481. Total cellulolytic activity is usually measured using insoluble substrates, including Whatman No.1 filter paper, microcrystalline cellulose, bacterial cellulose, algal cellulose, cotton, pretreated lignocellulose, etc. The most common total cellulolytic activity assay is the filter paper assay using Whatman No.1 filter paper as the substrate. The assay was established by the International Union of Pure and Applied Chemistry (IUPAC) (Ghose, 1987, Measurement of cellulase activities, Pure Appl. Chem. 59: 257-68). Cellulases includes enzymes that catalyze the hydrolysis of the 1,4-beta-D-glycosidic linkages in cellulose, hemicellulose, lichenin, and cereal beta-D-glucans. The term cellulase includes endo-1,4-beta-D-glucanase (beta-1,4-glucanase, beta-1,4-endoglucan hydrolase, endoglucanase D, 1,4-(1,3,1,4)-beta-D-glucan 4-glucanohydrolase) and carboxymethyl cellulase. Cellulases includes endo-cellulases (EC 3.2.1.4) which randomly cleave internal bonds at amorphous sites that create new chain ends and exocellulases (EC 3.2.1.91) that cleave two to four units from the ends of the exposed chains produced by endocellulase, resulting in tetrasaccharides or disaccharides, such as cellobiose. Exocellulases are further classified into type I, that work progressively from the reducing end of the cellulose chain, and type II, that work progressively from the non-reducing end. Suitable cellulases include complete cellulases or mono-component endoglucanases of bacterial or fungal origin. Chemically or genetically modified mutants are included. The cellulase may for example be a mono-component or a mixture of mono-component endo-1,4-beta-glucanase often just termed endoglucanases. Cellulases include enzymes having xyloglucanase activity Cellulase activity may be determined as described in Assay IV in the Examples herein.

Cellulosic material: The term “cellulosic material” means any material containing cellulose. The predominant polysaccharide in the primary cell wall of biomass is cellulose, the second most abundant is hemicellulose, and the third is pectin. The secondary cell wall, produced after the cell has stopped growing, also contains polysaccharides and is strengthened by polymeric lignin covalently cross-linked to hemicellulose. Cellulose is a homopolymer of anhydrocellobiose and thus a linear beta-(1-4)-D-glucan, while hemicelluloses include a variety of compounds, such as xylans, xyloglucans, arabinoxylans, and mannans in complex branched structures with a spectrum of substituents. Although generally polymorphous, cellulose is found in plant tissue primarily as an insoluble crystalline matrix of parallel glucan chains. Hemicelluloses usually hydrogen bond to cellulose, as well as to other hemicelluloses, which helps stabilize the cell wall matrix.

DNase: The term DNase as used herein means a polypeptide with DNase (deoxyribonuclease) activity that catalyze the hydrolytic cleavage of phosphodiester linkages in a DNA backbone, thus degrading DNA. Exodeoxyribonuclease cut or cleaves residues at the end of the DNA back bone where endo-deoxyribonucleases cleaves or cut within the DNA backbone. A DNase may cleave only double-stranded DNA or may cleave double stranded and single stranded DNA. The term “DNases” and the expression “a polypeptide with DNase activity” may be used interchangeably throughout the application. For purposes of the present invention, DNase activity is determined according to the procedure described in the Assay I or Assay II. Preferably the DNase is selected from any of the enzyme classes E.C.3.1, preferably E.C.3.1.21. Preferably, the polypeptide having DNase activity is obtained from a microorganism and the DNase is a microbial enzyme. The DNase is preferably of fungal or even more preferably of bacterial origin.

Deep Cleaning: The term “deep cleaning” means reduction, disruption or removal of components, which may be comprised in organic matter, e.g. skin debris, dead cell material, sebum, sweat and biofilm, such as polysaccharides, grease, proteins, starch, DNA, soil or other components present in the organic matter. The organic matter may be termed poly-organic stains comprising more than one organic component such as starch, grease, protein, DNA and mannan.

Enzyme Detergency Benefit: The term “enzyme detergency benefit” used herein, refers to the advantageous effect an enzyme may add to a detergent compared to the same detergent without the enzyme. Important detergency benefits which can be provided by enzymes are stain removal with no or very little visible soils after washing and/or cleaning, prevention or reduction of re-deposition of soils released in the washing process (an effect that also is termed anti-redeposition), restoring fully or partly the whiteness of textiles which originally were white but after repeated use and wash have obtained a greyish or yellowish appearance (an effect that also is termed whitening). Textile care benefits, which are not directly related to catalytic stain removal or prevention of re-deposition of soils, may also be important for enzyme detergency benefits. Examples of such textile care benefits are prevention or reduction of dye transfer from one fabric to another fabric or another part of the same fabric (an effect that is also termed dye transfer inhibition or anti-backstaining), removal of protruding or broken fibers from a fabric surface to decrease pilling tendencies or remove already existing pills or fuzz (an effect that also is termed anti-pilling), improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching component such as hydrogen peroxide or other peroxides.

Fabric: The term “fabric” is used interchangeably with “textile” and means material including yarns, yarn intermediates, fibers, non-woven materials, natural materials, synthetic materials, and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell).

Hard surface cleaning: The term “hard surface cleaning” as used herein, refers to cleaning of any hard surfaces including floors, roofs, cars, kitchen or bathroom surfaces, as well as dish cleaning (dish-washing).

Lipase: The term lipase as used herein, includes enzymes which catalyze the hydrolysis of fats (lipids). Lipases are a sub class of esterases. Lipases suitable in the present invention include phospholipases, acyltransferases or perhydrolases e.g. acyltransferases with homology to Candida antarctica lipase A (WO10/111143), acyltransferase from Mycobacterium smegmatis (WO05/56782), perhydrolases from the CE 7 family (WO09/67279), and variants of the M smegmatis perhydrolase in particular the S54V variant used in the commercial product Gentle Power Bleach from Huntsman Textile Effects Pte Ltd (WO10/100028). Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147). Lipase activity may be determined as described in Assay V in the Examples herein.

Low temperature: “Low temperature” is a temperature of 5-40° C., or 5-35° C., or 5-30° C., or even 5-25° C., or 5-20° C., or 5-15° C., or 5-10° C. Preferably, “Low temperature” is a temperature of 10-35° C., preferably 10-30° C., or 10-25° C., or 10-20° C., or 10-15° C.

Mannanase: The term as used herein includes enzymes that catalyze the hydrolysis of mannans, which is a highly branched polymer of mannose. The mannanases as used herein are preferably of microbial origin such as bacterial or fungal mannanases. The mannanase preferably having mannan endo-1,4-beta-mannosidase activity (EC 3.2.1 .78) that catalyze the hydrolysis of 1 ,4-3-D-mannosidic linkages in mannans, galactomannans and/or glucomannans. The mannanase may be a GH₅ mannanase such as an endo-1,4β-Mannanase or a GH₂₆ endo-1,4β-Mannanase. Mannanase activity may be determined as described in Assay VI in the Examples herein.

Mature polypeptide: The term “mature polypeptide” means a polypeptide in its final form following translation and any post-translational modifications, such as N-terminal processing, C-terminal truncation, glycosylation, phosphorylation, etc. It is known in the art that a host cell may produce a mixture of two of more different mature polypeptides (i.e., with a different C-terminal and/or N-terminal amino acid) expressed by the same polynucleotide.

Mutant: The term “mutant” means a polynucleotide encoding a variant. Protease: As used herein, the term protease includes enzymes that hydrolyze peptide bonds and the term incudes peptidase and proteinase. Serine proteases (or serine endopeptidases), E.C. 3.4.21 are enzymes that cleave peptide bonds in proteins, in which serine serves as the nucleophilic amino acid at the active site. Suitable proteases include those of bacterial, fungal, plant, viral or animal origin e.g. vegetable or microbial origin. Microbial origin is preferred. Chemically modified or protein engineered mutants are included. Most relevant proteases for laundry may be the alkaline proteases, such as a serine protease. A serine protease may for example be of the S1 family, such as trypsin, or the S8 family such as subtilisin. A metalloproteases protease may for example be a thermolysin from e.g. family M4 or other metalloproteases such as those from M5, M7 or M8 families. The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family. Protease activity may be determined as described in Assay VII in the Examples herein.

Sequence Identity: The relatedness between two amino acid sequences or between two nucleotide sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used may be gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

Textile Care Benefits: The term “textile care benefits”, as used herein, is defined as not being directly related to catalytic stain removal or prevention of re-deposition of soils, are also important for enzyme detergency benefits. Examples of such textile care benefits are prevention or reduction of dye transfer from one textile to another textile or another part of the same textile (dye transfer inhibition), removal of protruding or broken fibers from a textile surface to decrease pilling tendencies or remove already existing pills or fuzz (anti-pilling), improvement of the textile-softness, color clarification of the textile and removal of particulate soils which are trapped in the fibers of the textile. Enzymatic bleaching is a further enzyme detergency benefit where the catalytic activity generally is used to catalyze the formation of bleaching component such as hydrogen peroxide or other peroxides or other bleaching species.

Variant: The term “variant” as used herein means a polypeptide having the activity of the parent or precursor polypeptide and comprising an alteration, i.e., a substitution, insertion, and/or deletion, at one or more (e.g., several) positions compared to the precursor or parent polypeptide.

A substitution means replacement of the amino acid occupying a position with a different amino acid; a deletion means removal of the amino acid occupying a position; and an insertion means adding an amino acid adjacent to and immediately following the amino acid occupying a position.

Wash performance: The term “wash performance” is used to refer to the ability of a composition or enzyme to remove stains present on the object to be cleaned e.g. during laundering or washing of hard surfaces. The term “wash performance” includes cleaning in general e.g. hard surface cleaning as in dish wash, but also wash performance on textiles such as laundry.

### Nomenclature

For purposes of the present invention, the nomenclature “E/Q” or EQ means that the amino acid at a given position may be a glutamic acid (Glu, E) or a glutamine (Gln, Q). Likewise, the nomenclature “V/G/A!I” or VGAI means that the amino acid at this position may be a valine (Val, V), glycine (Gly, G), alanine (Ala, A) or isoleucine (Ile, I), and so forth for other combinations as described herein. Unless otherwise limited further, the amino acid X is defined such that it may be any of the 20 natural amino acids.

Substitutions are typically indicated with the original amino acid (the amino acid present in a parent sequence), the position number, and the replacement amino acid. For example, A226V indicates that the alanine residue in position 226 has been replaced by a valine residue. Different parent enzymes may have different amino acids in the position corresponding to position 226 of the parent sequence. Thus, A226V is not limited to substitutions of alanine. Any amino acid may be replaced in the substitution, which may also be indicated with an X as X226V. Both annotations may be used interchangeably. The substitution A226V, may also be written e.g. enzyme X comprising valine at a position corresponding to position 226 of SEQ ID NO: XX.

Deletions are indicated with an asterisk (*). For example, G184* indicates that the original glycine residue in position 184 has been deleted.

Insertions are indicated by listing the original amino acid, the position number, the original amino acid and the inserted amino acid. For example, S97SD indicates that an aspartic acid residue has been inserted after the serine residue in position 97.

Multiple alternative mutations may be separated by commas e.g. T51I, S52Q, N54K, meaning that one or more maybe all of the listed mutations may be present. Thus, meaning the above example that either one, two or three (thus all) of the mutations may present compared to the parent enzyme.

When mutations in alteration sets are separated by commas this means that all the alterations in the set are present and the selection is between the lists of alterations (alteration sets). E.g. “comprising one of the alterations sets selected from the group consisting of”
a. H_{1*,} D183*, G184*, N195F, V206Y;
b. H_{1*,} D183*, G184*, N195F, M202L, V206L, R320K, R458K; . . . means the selection is made between a., b. etc. of the alteration sets. Thus, a set is then a list of alterations which is all present though separated by commas.

SEQ ID NO: XX+mutation(s) is to be understood as variants of an enzyme parent comprising specified mutations compared to the specific parent sequence.

The term “corresponding to” reflects the numbering system used and that various starting enzymes, for example starting proteases (parent proteases) may have different lengths. Thus, in the case of an amylase with numbering corresponding to e.g. SEQ ID NO: 2, a given starting amylase is aligned with SEQ ID NO: 2 and the position in the starting amylase corresponding to a given position in SEQ ID NO: 2, e.g. position 140, is determined.

The terms parent enzyme includes terms such as reference enzyme, back bone or starting enzyme and is used to denote the enzyme into which to mutations e.g. substitutions are made. The terms may be used interchangeably.

### DETAILED DESCRIPTION OF THE INVENTION

### Cleaning Compositions

The present invention relates to a cleaning composition comprising a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1, optionally with the proviso that the DNase is not the DNase shown in SEQ ID NO: 36; at least one additional enzyme selected from the group consisting of mannanases, amylases, cellulases, lipases and proteases; and a cleaning adjunct, preferably comprising a surfactant.

The cleaning composition of the present invention preferably relates to products for and/or methods relating to and/or use of the claimed compositions for air care, car care, dish-washing, laundry cleaning, care, (conditioning and/or softening), laundry and rinse additives, hard surface cleaning and/or treatment, and other cleaning for consumer or institutional use. Preferably the composition comprises a laundry detergent or hard surface cleaning composition, for cleaning surfaces such as floors, walls, or dish-washing composition. The composition of the invention may be a solid (for example, a bar, tablet, powder, granules), liquid, gel and/or paste or may be in the form of a sheet. A preferred form is a unit dose form which may be a tablet, sheet, or preferably a pouch comprising liquid and/or solid compositions. Preferred are multi-compartment pouches. The composition may be a powder-form all-purpose “heavy-duty” washing agent, a paste-form all-purpose, a heavy-duty liquid type, a liquid fine-fabric, a hand dishwashing agent, a light duty dishwashing agent, a high-foaming type, a machine dishwashing agent. The dishwashing composition may be in the form of a liquid, gel or powder and it may be in the form of a unit dose, such as a tablet or pouch, and is preferably a main wash composition or a rinse-aid type. The composition can also be in unit dose packages, including those known in the art and those that are water soluble, water insoluble and/or water permeable. A liquid detergent may be aqueous, typically containing up to 70% water and 0-30% organic solvent, or non-aqueous or a solution containing more than 0.5 g/L of the detergent composition.

The composition of the invention may for example be formulated as a hand or machine laundry detergent composition including a laundry additive composition suitable for pre-treatment of stained fabrics and a rinse added fabric softener composition, or be formulated as a detergent composition for use in general household hard surface cleaning operations, or be formulated for hand or machine dishwashing operations.

Preferred unit dose compositions comprise solid (preferably in the form of a powder), or liquid or a combination thereof, preferably in a multi-compartment unit dose. Especially preferred is a unit dose form comprising liquid detergent encapsulated in water-soluble material in the form of a pouch, optionally in the form of a multi-component pouch. A preferred unit dose comprises liquid laundry detergent/care composition, optionally in a unit dose form.

The cleaning composition of the invention may be in the form of soap bar, preferably a laundry soap bar and may be used for hand washing laundry, fabrics and/or textiles. The term laundry soap bar includes laundry bars, soap bars, combo bars, syndet bars and detergent bars.

### DNase Enzyme

A suitable DNase enzyme for use herein comprises a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1, preferably the DNase will be a DNase having at least 90%, at least 91%, at least 92%, at least 93%, at least 94%, at least 95%, at least 96%, at least 97%, at least 98%, at least 99% or 100% sequence identity to the DNase shown in SEQ ID NO: 1.

In one embodiment, the DNase comprises a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1, with the proviso that the DNase is not the DNase shown in SEQ ID NO: 36.

A preferred DNase for use herein comprises a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1, wherein the DNase comprises Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and/or Aspartic acid at position 175, wherein the position corresponds to the position of SEQ ID NO: 1 (numbered according to SEQ ID NO: 1).

In a preferred embodiment the DNase further comprises Isoleucine at position 1, Lysine at position 4, Proline at position 25, Tryptophan at position 57, Alanine at position 130 and/or Histidine at position 147, wherein the position corresponds to the position of SEQ ID NO: 1 (numbered according to SEQ ID NO: 1).

A preferred DNase for use herein comprises a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1, wherein the DNase comprises Isoleucine at position 1, Lysine at position 4, Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and/or Aspartic acid at position 175.

In one preferred embodiment the enzyme composition comprises a DNase having at least 60%, at least 65%, at least 70%, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the DNase shown in SEQ ID NO: 1, wherein the DNase comprises;
i) Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
ii) Isoleucine at position 1,Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175.Lysine at position 4,Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
iii) Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
iv) Tyrosine at position 13, Proline at position 22, Leucine at position 27, Lysine at position 33, Proline at position 39, Glycine at position 42, Isoleucine at position 56, Tryptophan at position 57; Valine at position 59, Valine at position 65, Leucine at position 76, Arginine at position 109, Aspartic acid at position 116, Valine at position 127, Proline at position 144, Leucine at position 167 and Aspartic acid at position 175;
v) Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
vi) Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Histidine at position 147, Leucine at position 167 and Aspartic acid at position 175;
vii) Isoleucine at position 1, Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
viii) Isoleucine at position 1, Lysine at position 4, Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
ix) Tyrosine at position 13, Proline at position 22, Leucine at position 27, Proline at position 25, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Leucine at position 167 and Aspartic acid at position 175;
x) Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xi) Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and Aspartic acid at position 175;
xii) Isoleucine at position 1, Lysine at position 4, Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
xiii) Lysine at position 4, Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Leucine at position 167 and Aspartic acid at position 175;

xiv) Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xv) Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and Aspartic acid at position 175;
xvi) Isoleucine at position 1, Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xvii) Isoleucine at position 1, Tyrosine at position 13, Proline at position 22, Leucine at position 27, Lysine at position 33, Proline at position 39, Glycine at position 42,

Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xviii) Isoleucine at position 1, Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Histidine at position 147, Leucine at position 167 and Aspartic acid at position 175;
xix) Lysine at position 4, Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xx) Lysine at position 4, Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Leucine at position 167 and Aspartic acid at position 175;
xxi) Lysine at position 4, Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and Aspartic acid at position 175;
xxii) Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xxiii) Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Histidine at position 147, Leucine at position 167 and Aspartic acid at position 175; or
xxiv) Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and Aspartic acid at position 175;wherein the position corresponds to the position of SEQ ID NO: 1 (numbered according to SEQ ID NO: 1); and
xxv) mixtures thereof.

Particularly useful DNases may be those of microbial origin. In one embodiment, the composition comprises a DNase from bacteria. One embodiment of the invention relates to an enzyme composition e.g. a cleaning composition comprising a DNase, an enzyme selected from a mannanase, an amylase, a cellulase, a lipase and a protease and at least one cleaning adjunct, wherein the DNase is obtained from Bacillus, preferably Bacillus cibi.

The term “obtained from” as used herein in connection with a given source shall mean that the enzyme of the invention is produced by the source or by a strain in which the polynucleotide encoding the enzyme of the invention from the source has been inserted. In one aspect, the enzyme obtained from a given source is secreted extracellularly.

### Additional Enzyme

The composition comprises an additional enzyme selected from the group consisting of mannanases, amylases, cellulases, lipases, proteases and mixtures thereof. This additional enzyme preferably comprises a cleaning enzyme. As used herein “cleaning enzyme” means an enzyme which provides an “Enzyme Detergency Benefit” (see definitions). Preferably such additional enzyme provides synergistic cleaning in combination with the DNase.

### Amylase

One preferred enzyme to be combined with the DNase enzyme is an amylase in particular an alpha-amylase (alpha-1,4-glucan-4-glucanohydrolases, E.C. 3.2.1.1). Amylases catalyze hydrolysis of starch and other linear and branched 1,4-gluosidic oligo- and polysaccharides. Amylases have several applications such as detergent, baking, brewing, starch liquefaction and saccharification e.g. in preparation of high fructose syrups or as part of ethanol production from starch. An alpha-amylase useful in a cleaning composition of the invention is preferably an enzyme classified under EC 3.2.1.1. One embodiment relates to an enzyme composition e.g. a cleaning composition comprising a DNase, an amylase, and a cleaning adjunct, preferably comprising a surfactant, wherein the DNase has at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, wherein the amylase is classified under EC 3.2.1.1. The alpha-amylase may be bacterial or fungal. A bacterial alpha-amylase to be used in a composition according to the invention may, e.g., be derived from a strain of the genus Bacillus, which is sometimes also referred to as the genus Geobacillus. In an embodiment the Bacillus alpha-amylase is derived from a strain of B. amyloliquefaciens, B. licheniformis, B. stearothermophilus, B. halmapalus, or B. subtilis, but may also be derived from another Bacillus sp. e.g. Bacillus TS-23 is described in WO2014/195356. The amylases may also be obtained from bacteria such as Cytophaga.

One embodiment relates to a an enzyme composition e.g. cleaning composition comprising a DNase, an amylase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, wherein the amylase is obtained from Bacillus e.g. B. amyloliquefaciens, B. licheniformis, B. stearothermophilus, B. halmapalus, or B. subtilis, Bacillus TS-23 or from Cytophaga.

One embodiment relates to an enzyme composition e.g. cleaning composition comprising a DNase, an amylase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 and wherein the amylase is selected from the group consisting of;

an amylase having at least 60%, at least 65%, at least 70%, at least 75%, at least 80%, at least 85%, at least 90%, at least 95%, at least 98% or 100% sequence identity to SEQ ID NO: 2 or SEQ ID NO: 35, or an amylase having at least 60%, at least 65%, at least 70%, at least 75%, at least 80%, at least 85%, at least 90%, at least 95%, at least 98% but less than 100% sequence identity to SEQ ID NO: 2 or SEQ ID NO: 35 comprising a two amino acid deletion in the sequence region R180, S181, T182, G183, compared to SEQ ID NO: 2, wherein each position corresponds to the position in SEQ ID NO: 2;
a) an amylase having at least 60%, at least 65%, at least 70%, at least 75%, at least 80%, at least 85%, at least 90%, at least 95%, at least 98% or 100% sequence identity to SEQ ID NO: 2 or SEQ ID NO: 35, or an amylase having at least 60%, at least 65%, at least 70%, at least 75%, at least 80%, at least 85%, at least 90%, at least 95%, at least 98% but less than 100% sequence identity to SEQ ID NO: 2 or SEQ ID NO: 35 comprising one of the alterations set selected from the group consisting of:
   a. R180*, S181*, S243Q, G475K;
   b. R180*, T182*, S243Q, G475K;
   c. R180*, T182*, G183S, S243Q, G475K; and
   d. R180*, S181*, Y242F, S243Q, F266Y, G475K compared to SEQ ID NO: 2, wherein each position corresponds to the position in SEQ ID NO: 2;
b) an amylase having at least 60%, at least 65%, at least 70%, at least 75%, at least 80%, at least 85%, at least 90%, at least 95%, at least 98% or 100% sequence identity to SEQ ID NO: 3, or an amylase having at least 60%, at least 65%, at least 70%, at least 75%, at least 80%, at least 85%, at least 90%, at least 95%, at least 98% but less than 100% sequence identity to SEQ ID NO: 3, comprising a two amino acid deletion in the sequence region R178, G179, T180, G181 compared to SEQ ID NO: 3, wherein each position corresponds to the position in SEQ ID NO: 3;
c) an amylase having at least 60%, at least 65%, at least 70%, at least 75%, at least 80%, at least 85%, at least 90%, at least 95%, at least 98% or 100% sequence identity to SEQ ID NO: 3, or an amylase having at least 60%, at least 65%, at least 70%, at least 75%, at least 80%, at least 85%, at least 90%, at least 95%, at least 98% but less than 100% sequence identity to SEQ ID NO: 3, comprising one of the alterations set selected from the group consisting of:
   I. R178*, G179*, E187P, I203Y, G476K;
   II. R178*, G179*, E187P, M199L, I203Y, G476K;
   III. R178*, G179*, E187P, I203Y R458N, T459S, D460T, G476K;
   IV. N126Y, F153W, R178*, G179*, T180H, I203Y, S241Q;
   V. N126Y, F153W, R178*, G179*, T180H, I203Y, S241Q, S362A, R377Y;
   VI. T38N, N126Y, T129I, F153W, R178*, G179*, T180D, E187P, I203Y, G476K, G477E; and
   VII. N126Y, F153W, R178*, G179*, T180H, E187P, I203Y, S241Q, G476K, G477E, compared to SEQ ID NO: 3, wherein each position corresponds to the position in SEQ ID NO: 3;
d) an amylase having at least 60%, at least 65%, at least 70%, at least 75%, at least 80%, at least 85%, at least 90%, at least 95%, at least 98% or 100% sequence identity to SEQ ID NO: 4, or an amylase having at least 60%, at least 65%, at least 70%, at least 75%, at least 80%, at least 85%, at least 90%, at least 95%, at least 98% but less than 100% sequence identity to SEQ ID NO: 4, comprising a two amino acid deletion in the sequence region R181, G182, D183, G184 compared to SEQ ID NO: 4, wherein each position corresponds to the position in SEQ ID NO: 4;
e) an amylase having at least 60%, at least 65%, at least 70%, at least 75%, at least 80%, at least 85%, at least 90%, at least 95%, at least 98% or 100% sequence identity to SEQ ID NO: 4, or an amylase having at least 60%, at least 65%, at least 70%, at least 75%, at least 80%, at least 85%, at least 90%, at least 95%, at least 98% but less than 100% sequence identity to SEQ ID NO: 4 comprising an alteration at one or more, preferably at all of the position(s) selected from 3, 4, 5, 74, 118, 167, 170, 177, 195, 202, 204, 271, 320, 330, 377, 385, 445, 458, 475, 476, 314, 315 or 316, compared to SEQ ID NO: 4, wherein each position corresponds to the position in SEQ ID NO: 4;
f) an amylase having at least 60%, at least 65%, at least 70%, at least 75%, at least 80%, at least 85%, at least 90%, at least 95%, at least 98% or 100% sequence identity to SEQ ID NO: 5, or an amylase having at least 60%, at least 65%, at least 70%, at least 75%, at least 80%, at least 85%, at least 90%, at least 95%, at least 98% but less than 100% sequence identity to SEQ ID NO: 5 preferably comprising a two amino acid deletion in the sequence region R181, G182, D183, G184, compared to SEQ ID NO: 5, wherein each position corresponds to the position in SEQ ID NO: 5;
g) an amylase having at least 60%, at least 65%, at least 70%, at least 75%, at least 80%, at least 85%, at least 90%, at least 95%, at least 98% or 100% sequence identity to SEQ ID NO: 5, or an amylase having at least 60%, at least 65%, at least 70%, at least 75%, at least 80%, at least 85%, at least 90%, at least 95%, at least 98% but less than 100% sequence identity to SEQ ID NO: 5 comprising one of the alterations set selected from the group consisting of
   a. D183*, G184*, N195F, Y243F;
   b. D183*, G184*, N195F, V206Y, Y243F;
   c. W140Y, D183*, G184*, N195F, V206Y, Y243F, E260G, G304R, G476K;
   d. W140Y, D183*, G184*, N195F, V206Y, Y243F, E260G, G477E;
   e. W140Y, D183*, G184*, N195F, V206Y, Y243F, W284D;
   f. W140Y, N195F, V206Y, Y243F, E260G, G477E;
   g. G109A, W140Y, N195F, V206Y, Y243F, E260G;
   h. T51I, S52Q, N54K, G109A, W140Y, N195F, V206Y, Y243F, E260G, G476E;
   i. W140Y, N195F, V206Y, Y243F, E260G, W284R, G477K;
   j. W140Y, N195F, V206Y, Y243F, E260G, W284F, G477R; and
   k. H_{1*,} G7A, G109A, W140Y, D183*, G184*, N195F, V206Y, Y243F, E260G, N280S, G304R, E391A, G476K, compared to SEQ ID NO: 5, wherein each position corresponds to the position in SEQ ID NO: 5;
h) an amylase having at least 60%, at least 65%, at least 70%, at least 75%, at least 80%, at least 85%, at least 90%, at least 95%, at least 98% or 100% sequence identity to SEQ ID NO: 6, or an amylase having at least 60%, at least 65%, at least 70%, at least 75%, at least 80%, at least 85%, at least 90%, at least 95%, at least 98% but less than 100% sequence identity to SEQ ID NO: 6, comprising a two amino acid deletion in the sequence region R181, G182, D183, G184, compared to SEQ ID NO: 6, wherein each position corresponds to the position in SEQ ID NO: 6;
i) an amylase having at least 60%, at least 65%, at least 70%, at least 75%, at least 80%, at least 85%, at least 90%, at least 95%, at least 98% or 100% sequence identity to SEQ ID NO: 6, or an amylase having at least 60%, at least 65%, at least 70%, at least 75%, at least 80%, at least 85%, at least 90%, at least 95%, at least 98% but less than 100% sequence identity to SEQ ID NO: 6, comprising one of the alterations set selected from the group consisting of
   I. R118K, D183*, G184*, N195F, R320K, R458K;
   II. M91, D183*, G184*, R118K, N195F, M202L, R320K, M323T, R458K;
   III. M9L, G149A, R118K, G182T, D183*, G184*, G186A, N195F, M202L, T257I, Y295F, N299Y, M323T, A339S, E345R, R458K;
   IV. M9L, G149A, R118K, G182T, D183*, G184*, G186A, N195F, T246V, T257I, Y295F, N299Y, M323T, A339S, E345R, R458K; and
   V. M9L, G149A, G182T, D183*, G184*, G186A, M202L, T257I, Y295F, N299Y, M323T, A339S, E345R, N471E, compared to SEQ ID NO: 6, wherein each position corresponds to the position in SEQ ID NO: 6;
j) an amylase having at least 60%, at least 65%, at least 70%, at least 75%, at least 80%, at least 85%, at least 90%, at least 95%, at least 98% or 100% sequence identity to SEQ ID NO: 7, or an amylase having at least 60%, at least 65%, at least 70%, at least 75%, at least 80%, at least 85%, at least 90%, at least 95%, at least 98% but less than 100% sequence identity to SEQ ID NO: 7, comprising a two amino acid deletion in the sequence region R181, G182, D183, G184, compared to SEQ ID NO: 7, wherein each position corresponds to the position in SEQ ID NO: 7;
k) an amylase having at least 60%, at least 65%, at least 70%, at least 75%, at least 80%, at least 85%, at least 90%, at least 95%, at least 98% or 100% sequence identity to SEQ ID NO: 7, or an amylase having at least 60%, at least 65%, at least 70%, at least 75%, at least 80%, at least 85%, at least 90%, at least 95%, at least 98% but less than 100% sequence identity to SEQ ID NO: 7, comprising one of the alterations set selected from the group consisting of
   a. D183*, G184*, N195F, V206Y, R320K, R458K;
   b. D183*, G184*, N195F, M202L, V206L, R320K, R458K;
   c. G149A, G182T, D183*, G184*, N195F, M202L, V206L, T257I, Y295F, Q299Y, A339S, Q345R, R458K;
   d. G149A, G182T, D183*, G184*, N195F, V206L, M246V, T257I, Y295F, Q299Y, A339S, Q345R, R458K;
   e. G149A, G182T, D183*, G184*, M202L, V206L, T257I, Y295F, Q299Y, A339S, Q345R, H₄₇₁E; and
   f. H₁A, N54S, V56T, K72R, G109A, F113Q, R116Q, W167F, Q172G, A174S, G182*, D183*, G184T, N195F, V206L, K391A, F473R, G476K, compared to SEQ ID NO: 7, wherein each position corresponds to the position in SEQ ID NO: 7;
l) an amylase having at least 60%, at least 65%, at least 70%, at least 75%, at least 80%, at least 85%, at least 90%, at least 95%, at least 98% or 100% sequence identity to SEQ ID NO: 8, or an amylase having at least 60%, at least 65%, at least 70%, at least 75%, at least 80%, at least 85%, at least 90%, at least 95%, at least 98% but less than 100% sequence identity to SEQ ID NO: 8, comprising a two amino acid deletion in the sequence region R181, G182, H_{183,} G184, compared to SEQ ID NO: 8, wherein each position corresponds to the position in SEQ ID NO: 8;
m) an amylase having at least 60%, at least 65%, at least 70%, at least 75%, at least 80%, at least 85%, at least 90%, at least 95%, at least 98% or 100% sequence identity to SEQ ID NO: 8, or an amylase having at least 60%, at least 65%, at least 70%, at least 75%, at least 80%, at least 85%, at least 90%, at least 95%, at least 98% but less than 100% sequence identity to SEQ ID NO: 8, comprising one of the alterations set selected from the group consisting of
   a. H_{183*,} G184*, I405L, A421H, A422P, A428T;
   b. R118K, H_{183*,} G184*, N195F, R320K, R458K;
   c. M91, H_{183*,} G184*, R118K, N195F, M202L, R320K, S323T, R458K;
   d. M9L, G149A, R118K, G182T, H_{183*,} G184*, N195F, M202L, T257I, Y295F, N299Y, A339S, E345R, R458K;
   e. M9L, G149A, R118K, G182T, H_{183*,} G184*, N195F, T246V, T257I, Y295F, N299Y, A339S, E345R, R458K; and
   f. M9L, G149A, G182T, H_{183*,} G184*, M202L, T257I, Y295F, N299Y, S323T, A339S, E345R, compared to SEQ ID NO: 8, wherein each position corresponds to the position in SEQ ID NO: 8;
n) an amylase having at least 60%, at least 65%, at least 70%, at least 75%, at least 80%, at least 85%, at least 90%, at least 95%, at least 98% or 100% sequence identity to SEQ ID NO: 9, or an amylase having at least 60%, at least 65%, at least 70%, at least 75%, at least 80%, at least 85%, at least 90%, at least 95%, at least 98% but less than 100% sequence identity to SEQ ID NO: 9, comprising a two amino acid deletion in the sequence region R181, G182, G182, D183, compared to SEQ ID NO: 9, wherein each position corresponds to the position in SEQ ID NO: 9; and
o) an amylase having at least 60%, at least 65%, at least 70%, at least 75%, at least 80%, at least 85%, at least 90%, at least 95%, at least 98% or 100% sequence identity to SEQ ID NO: 9, or an amylase having at least 60%, at least 65%, at least 70%, at least 75%, at least 80%, at least 85%, at least 90%, at least 95%, at least 98% but less than 100% sequence identity to SEQ ID NO: 9, comprising one of the alterations set selected from the group consisting of
   a. H_{1*,} D183*, G184*, N195F, V206Y;
   b. H_{1*,} D183*, G184*, N195F, M202L, V206L, R320K, R458K;
   c. G149A, G182T, D183*, G184*, N195F, M202L, V206L, T257I, Y295F, Q299Y, A339S, Q345R, R458K;
   d. G149A, G182T, D183*, G184*, N195F, V206L, M246V, T257I, Y295F, Q299Y, A339S, Q345R, R458K;
   e. G149A, G182T, D183*, G184*, M202L, V206L, T257I, Y295F, Q299Y, A339S, Q345R,
   f. H_{1*,} N54S, V56T, G109A, Q169E, Q172K, A174*, G182*, D183*, N195F, V206L, K391A, G476K;
   g. G182*, D183*, N195F, W140Y, N260G, 5304R, R320A, G476K, V410I, V4291, F451W, C₄₇₄V;
   h. H_{1*,} N54S, V56T, K72R, G109A, F113Q, R116Q, W167F, Q172G, A174S, G182*, D183*, G184T, N195F, V206L, K391A, P473R, G476K;
   i. H_{1*,} N54S, V56T, G109A, Q169E, Q172K, A174*, G182*, D183*, N195F, V206L, K391A, G476K;
   j. H_{1*,} N54S, V56T, G109A, R116H, A174S, G182*, D183*, N195F, V206L, K391A, G476K;
   k. H_{1*,} N54S, V56T, K72R, G109A, F113Q, R116Q, W167F, Q172G, A174S, G182*, D183*, G184T, N195F, V206L, K391A, P473R, G476K;
   l. H_{1*,} N54S, V56T, G109A, F113Q, R116Q, Q172N, A174S, G182*, D183*, N195F, V206L, A265G, K391A, P473R, G476K;
   m. H_{1*,} N54S, V56T, K72R, G109A, F113Q, W167F, Q172R, A174S, G182*, D183*, N195F, V206L, K391A, G476K;
   n. H_{1*,} N54S, V56T, K72R, G109A, R116H, T134E, W167F, Q172G, L173V, A174S, G182*, D183*, N195F, V206L, G255A, K391A, G476K;
   o. H_{1*,} N54S, V56T, K72R, G109A, R116H, T134E, W167F, Q172G, L173V, A174S, G182*, D183*, N195F, V206L, G255A, K391A, Q395P, T444Q, P473R, G476K;
   p. H_{1*,} N54S, V56T, G109A, T134E, A174S, G182*, D183*, N195F, V206L, K391A, G476K;
   q. H_{1*,} N54S, V56T, K72R, G109A, A174S, G182*, D183*, N195F, V206L, G255A, K391A, G476K;
   r. H_{1*,} N54S, V56T, G109A, W167F, Q172E, L173P, A174K, G182*, D183*, N195F, V206L, K391A, G476K;
   s. H_{1*,} N54S, V56T, G109A, R116Q, V120L, Q172G, L173V, A174S, G182*, D183*, G184T, N195F, V206L, A422P; and
   t. H_{1*,} N54S, V56T, G109A, F113Q, R116Q, W167F, Q172G, 1173V, A174S, G182*, D183*, G184T, N195F, V206L, A422P compared to SEQ ID NO: 9, wherein each position corresponds to the position in SEQ ID NO: 9.

### Cellulase

One preferred enzyme to be combined with the DNase enzyme is a cellulase in particular an enzyme exhibiting endo-beta-1,4-glucanase activity. Cellulose is a polymer of glucose linked by beta-1,4-glucosidic bonds. Cellulose chains form numerous intra- and intermolecular hydrogen bonds, which results in the formation of insoluble cellulose micro-fibrils. Microbial hydrolysis of cellulose to glucose involve three major classes of cellulases: (i) endo-glucanases (EC 3.2.1.4) which cleave beta-1,4-glucosidic links randomly throughout cellulose molecules, also called endo-beta-1,4-glucanases; (ii) cellobiohydrolases (EC 3.2.1.91) which digest cellulose from the non-reducing end, releasing cellobiose; and (iii) beta-glucosidases (EC 3.2.1.21) which hydrolyse cellobiose and low molecular-weight cellodextrins to release glucose. The cellulases useful in the composition of the invention are preferably endo-glucanases (EC 3.2.1.4). Beta-1,4-glucosidic bonds are also present beta-glucans from plants such as barley and oats. In some cases, endo-glucanases also provide hydrolysis of such non-cellulose polymers. The cellulases are placed into different families of glycosyl hydrolases; fungal and bacterial glycosyl hydrolases have been grouped into 35 families (Henrissat, B.: A classification of glycosyl hydrolases based on amino acid sequence similarities. Biochem. J. 280 (1991), 309-316. Henrissat, B., and Bairoch, A.: New families in the classification of glycosyl hydrolases based on amino acid sequence similarities. Biochem. J. 293 (1993), 781-788.). Most cellulases comprises or consists of a cellulose-binding domain (CBD) and a catalytic domain (CAD) separated by a linker which may be rich in proline and hydroxy amino acid residues. Another classification of cellulases has been established on the basis of the similarity of their CBDs (Gilkes et al. (1991)) giving five families of glycosyl hydrolases (I-V). Cellulases are synthesized by a large number of microorganisms which include fungi, actinomycetes, myxobacteria and true bacteria but also by plants. Especially endo-beta-1,4-glucanases of a wide variety of specificities have been identified. Many bacterial endo-glucanases have been described (Gilbert, H. J. and Hazlewood, G. P. (1993) J. Gen. Microbiol. 139:187-194. Henrissat, B., and Bairoch, A.: New families in the classification of glycosyl hydrolases based on amino acid sequence similarities. Biochem. J. 293 (1993), 781-788.). One preferred cellulase includes endo-beta-1,4-glucanase activity (EC 3.2.1.4), preferably obtained from Bacillus sp. AA349 (DSM 12648), as described in WO2002/099091. Other cellulases that are endo-beta-1,4-glucanase enzyme, includes the cellulase shown in SEQ ID NO: 10 Other preferred cellulases include those described in WO1996/029397, which discloses family 45 endoglucanases e.g. cellulases from Thielavia in particular a strain of Thielavia terrestris and the cellulases described in WO1991/017243, which discloses endoglucanases from e.g. of Humicola such as Humicola insolens.

Suitable cellulases include those from the genera Bacillus, Pseudomonas, Humicola, Myceliophthora, Fusarium, Thielavia, Trichoderma, and Acremonium. Exemplary cellulases include a fungal cellulase from Humicola insolens (US 4,435,307) or from Trichoderma, e.g. T. reesei or T. viride. Other suitable cellulases are from Thielavia e.g. Thielavia terrestris as described in WO 96/29397 or the fungal cellulases produced from Myceliophthora thermophila and Fusarium oxysporum disclosed in U.S. Pat. Nos. 5,648,263, 5,691,178, 5,776,757, WO 89/09259 and WO 91/17244. Also relevant are cellulases from Bacillus as described in WO 02/099091 and JP 2000210081. Suitable cellulases are alkaline or neutral cellulases having care benefits. Examples of cellulases are described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307.

Cellulases includes a family 44 xyloglucanase, which a xyloglucanase enzyme such as the xyloglucanase shown in SEQ ID NO: 31.

One embodiment relates to an enzyme composition e.g. cleaning composition comprising a DNase, a cellulase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, wherein the cellulase belongs to (EC 3.2.1.4), (EC 3.2.1.91) or (EC 3.2.1.21).

One embodiment relates to an enzyme composition e.g. cleaning composition comprising a DNase, a cellulase, and a cleaning adjunct, preferably comprising a surfactant, wherein the DNase has at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, wherein the cellulase is obtained from Thielavia, Humicola, Paenibacillus or Melanocarpus preferably Thielavia terrestris, Humicola insolens, Paenibacillus polymyxa or Melanocarpus albomyces.

One embodiment relates to an enzyme composition e.g. a cleaning composition comprising a DNase, a cellulase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, wherein the cellulase is selected from the group consisting of;
a) a cellulase having at least 60%, at least 65%, at least 70%, at least 75%, at least 80%, at least 85%, at least 90%, at least 95%, at least 98% or 100% sequence identity to
b) a cellulase having at least 60%, at least 65%, at least 70%, at least 75%, at least 80%, at least 85%, at least 90%, at least 95%, at least 98% or 100% sequence identity to SEQ ID NO: 11;
c) a cellulase having at least 60%, at least 65%, at least 70%, at least 75%, at least 80%, at least 85%, at least 90%, at least 95%, at least 98% or 100% sequence identity to SEQ ID NO: 12
d) a cellulase having at least 60%, at least 65%, at least 70%, at least 75%, at least 80%, at least 85%, at least 90%, at least 95%, at least 98% or 100% sequence identity to SEQ ID NO: 13,
e) a cellulase having at least 60%, at least 65%, at least 70%, at least 75%, at least 80%, at least 85%, at least 90%, at least 95%, at least 98% or 100% sequence identity to SEQ ID NO: 31, and
f) a cellulase having at least 60%, at least 65%, at least 70%, at least 75%, at least 80%, at least 85%, at least 90%, at least 95%, at least 98% or 100% sequence identity to SEQ ID NO: 32.

One embodiment relates to an enzyme composition e.g. cleaning composition comprising a DNase, a cellulase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, with the proviso that the DNase is not the DNase shown in SEQ ID NO: 36 and wherein the cellulase has at least 60%, at least 65%, at least 70%, at least 75%, at least 80%, at least 85%, at least 90%, at least 95%, at least 98% or 100% sequence identity to SEQ ID NO: 10, and preferably is obtained from Bacillus.

One embodiment relates to an enzyme composition e.g. a cleaning composition comprising a DNase, a cellulase, preferably and a cleaning adjunct, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, with the proviso that the DNase is not the DNase shown in SEQ ID NO: 36 and wherein the cellulase has at least 60%, at least 65%, at least 70%, at least 75%, at least 80%, at least 85%, at least 90%, at least 95%, at least 98% or 100% sequence identity to SEQ ID NO: 11, and preferably is obtained from Humicola e.g. Humicola insolens.

One embodiment relates to an enzyme composition e.g. a cleaning composition comprising a DNase, a cellulase, and a cleaning adjunct preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, with the proviso that the DNase is not the DNase shown in SEQ ID NO: 36 and wherein the cellulase has at least 60%, at least 65%, at least 70%, at least 75%, at least 80%, at least 85%, at least 90%, at least 95%, at least 98% or 100% sequence identity to SEQ ID NO: 12, and preferably is obtained from Humicola e.g. Humicola insolens.

One embodiment relates to an enzyme composition e.g. a cleaning composition comprising a DNase, a cellulase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, with the proviso that the DNase is not the DNase shown in SEQ ID NO: 36 and wherein the cellulase has at least 60%, at least 65%, at least 70%, at least 75%, at least 80%, at least 85%, at least 90%, at least 95%, at least 98% or 100% sequence identity to SEQ ID NO: 13, and preferably is obtained from Thielavia e.g. Thielavia terrestris.

One embodiment relates to an enzyme composition e.g. a cleaning composition comprising a DNase, a cellulase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, with the proviso that the DNase is not the DNase shown in SEQ ID NO: 36 and wherein the cellulase has at least 60%, at least 65%, at least 70%, at least 75%, at least 80%, at least 85%, at least 90%, at least 95%, at least 98% or 100% sequence identity to SEQ ID NO: 31, and preferably is obtained from Paenibacillus e.g. Paenibacillus polymyxa.

One embodiment relates to an enzyme composition e.g. a cleaning composition comprising a DNase, a cellulase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, with the proviso that the DNase is not the DNase shown in SEQ ID NO: 36 and wherein the cellulase has at least 60%, at least 65%, at least 70%, at least 75%, at least 80%, at least 85%, at least 90%, at least 95%, at least 98% or 100% sequence identity to SEQ ID NO: 32, and preferably is obtained from Melanocarpus e.g. Melanocarpus albomyces.

Lipase

One preferred enzyme to be combined with the DNase enzyme is a lipase. Lipases are enzymes that catalyze the hydrolysis of fats (lipids). Lipases are used in detergents for removal of grease stains. Lipases E.C. 3.1.1. are a subclass of the esterases E.C. 3.1. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (US5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

One embodiment relates to an enzyme composition e.g. a cleaning composition comprising a DNase, a lipase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1, wherein the lipase belongs to E.C. 3.1.1.

One embodiment relates to an enzyme composition e.g. a cleaning composition comprising a DNase, a lipase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1, wherein the lipase is obtained from Thermomyces, e.g. from T. lanuginosus, Pseudomonas e.g. P. alcaligenes or P. pseudoalcaligenes, P. cepacia, P. sp. strain SD705, P. wisconsinensis, Pseudomonas mendocina, Streptomyces, Magnaporthe e.g. M. grisea, Thermobifida e.g. T. fusca, Geobacillus e.g. G. stearothermophilus, Bacillus e.g. B. subtilis, Streptomyces e.g. S. griseus or S. pristinaespiralis.

One embodiment relates to an enzyme composition e.g. a cleaning composition comprising a DNase, an lipase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1, wherein the lipase is a lipase having at least 60%, at least 65%, at least 70%, at least 75%, at least 80%, at least 85%, at least 90%, at least 95%, at least 98% or 100% sequence identity to SEQ ID NO: 14, or a lipase having at least 60%, at least 65%, at least 70%, at least 75%, at least 80%, at least 85%, at least 90%, at least 95%, at least 98% but less than 100% sequence identity to SEQ ID NO: 14 comprising one or more of the substitutions selected from the group consisting of D27R, G38A, G91A/Q, D96E, G163K, T231R, N233R, D254S and P256T, compared to SEQ ID NO: 14, wherein each position corresponds to the position in SEQ ID NO: 14.

One embodiment relates to an enzyme composition e.g. a cleaning composition comprising a DNase, an lipase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1, wherein the lipase is a lipase having at least 60%, at least 65%, at least 70%, at least 75%, at least 80%, at least 85%, at least 90%, at least 95%, at least 98% but less than 100% sequence identity to SEQ ID NO: 14, wherein the lipase comprises one or both the substitutions T231R and/or N233R, wherein the position corresponds to the positions of SEQ ID NO: 14.

The lipase is preferably a “first cycle lipase”, for example those sold under the tradenames Lipex® and Lipolex®.

### Mannanase

Preferably the composition comprises a mannanase. Mannanases are enzyme catalyzing hydrolyses of 1,4-beta-D-mannosidic linkages in mannans, galactomannans, glucomannans, and galactoglucomannans. Mannans are a type of hemicellulose representing up to 25% of wood dry weight in softwoods, but are also found in other plant material, especially in a variety of seeds. Mannans are polysaccharides with a backbone of β-1,4-linked D-mannopyranosyl residues, which can contain galactose or acetyl substitutions and may have glucose residues in the backbone. The main enzyme type participating in the degradation of mannans are endo-1,4-β-mannanases (EC 3.2.1.78), which hydrolyze the internal glycoside bonds in the mannan backbone. The present invention provides a cleaning composition comprising a DNase and a mannanase enzyme comprising a polypeptide having mannan endo-1,4-beta-mannosidase activity (EC 3.2.1 .78) that catalyze the hydrolysis of 1,4-3-D-mannosidic linkages in mannans, galactomannans and/or glucomannans. According to CAZy (www.cazy.org), endo-1,4β-mannanases can be found in glycoside hydrolase families 5, 26 and 113. Couturier et al. have reported a GH₂₆ mannanase from Podospora anserina having 56.1% and 76.4% identity to SEQ ID NO: 3 and 6 respectively in (2013), “Structural and Biochemical Analyses of Glycoside Hydrolase Families 5 and 26-(1,4)-Mannanases from Podospora anserina Reveal Differences upon Manno-oligosaccharide Catalysis”, J. Biol. Chem., 288(20): 14624-14635. Preferred mannanases include the GH₅ mannanase obtained from Bacillus bogoriensis described in WO1999/064619 or any of the GH₂₆ Mannanases, mannanase from Preussia aemulans WO 2017/021515 (SEQ ID NO: 2), mannanase from Yunnania penicillata WO2017/021516 (SEQ ID NO: 2), mannanase from Myrothecium roridum WO2017/021517 (SEQ ID NO: 2), mannanase from Chaetomium brasiliense WO2017/021518 (SEQ ID NO: 2), mannanases from Ascobolus stictoideus or mannanase from Chaetomium virescens SEQ ID NO: 3 and 6 from WO2015/040159.

One embodiment relates to an enzyme composition e.g. a cleaning composition comprising a DNase, an mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1, wherein the mannanase belongs to EC 3.2.1.78.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1, wherein the mannanase comprises a GH₅ and/or a GH₂₆ mannanase, preferably a GH₅ mannanase.

One embodiment relates to an enzyme composition e.g. a cleaning composition comprising a DNase, an mannanase, and a cleaning adjunct, preferably comprising a surfactant, wherein the DNase has at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, wherein the mannanase is obtained from Bacillus e.g. B. bogoriensis or hemicellulosilyticus, Paenibacillus e.g. P. woosongensis or P. illinoisensis, Neobulgaria sp., Preussia e.g. P. aemulans, Yunnania e.g. Y. penicillata, Myrothecium e.g. M. roridum, Chaetomium e.g. C. brasiliense, Ascobolus e.g. A. stictoideus or Chaetomium e.g. C. virescens.

One embodiment relates to an enzyme composition e.g. a cleaning composition comprising a DNase, an mannanase, and a cleaning adjunct, preferably comprising a surfactant, wherein the

DNase has at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, wherein the mannanase is selected from the group consisting of;
a) a mannanase, wherein the mannanase preferably belongs to the Glycoside Hydrolase Family 5 mannanases;
   i. a mannanase having at least 60%, at least 65%, at least 70%, at least 75%, at least 80%, at least 85%, at least 90%, at least 95%, at least 98% or 100% sequence identity to SEQ ID NO: 15;
b) a mannanase wherein the mannanase preferably belongs to the Glycoside Hydrolase Family 26 mannanases;
   i. a mannanase having at least 60%, at least 65%, at least 70%, at least 75%, at least 80%, at least 85%, at least 90%, at least 95%, at least 98% or 100% sequence identity to SEQ ID NO: 16;
   ii. a mannanase having at least 60%, at least 65%, at least 70%, at least 75%, at least 80%, at least 85%, at least 90%, at least 95%, at least 98% or 100% sequence identity to SEQ ID NO: 17;
   iii. a mannanase having at least 60%, at least 65%, at least 70%, at least 75%, at least 80%, at least 85%, at least 90%, at least 95%, at least 98% or 100% sequence identity to SEQ ID NO: 18;
   iv. a mannanase having at least 60%, at least 65%, at least 70%, at least 75%, at least 80%, at least 85%, at least 90%, at least 95%, at least 98% or 100% sequence identity to SEQ ID NO: 19;
   v. a mannanase having at least 60%, at least 65%, at least 70%, at least 75%, at least 80%, at least 85%, at least 90%, at least 95%, at least 98% or 100% sequence identity to SEQ ID NO: 20;
   vi. a mannanase having at least 60%, at least 65%, at least 70%, at least 75%, at least 80%, at least 85%, at least 90%, at least 95%, at least 98% or 100% sequence identity to SEQ ID NO: 21;
   vii. a mannanase having at least 60%, at least 65%, at least 70%, at least 75%, at least 80%, at least 85%, at least 90%, at least 95%, at least 98% or 100% sequence identity to SEQ ID NO: 22;
   viii. a mannanase having at least 60%, at least 65%, at least 70%, at least 75%, at least 80%, at least 85%, at least 90%, at least 95%, at least 98% or 100% sequence identity to SEQ ID NO: 23;
   ix. a mannanase having at least 60%, at least 65%, at least 70%, at least 75%, at least 80%, at least 85%, at least 90%, at least 95%, at least 98% or 100% sequence identity to SEQ ID NO: 24;
   x. a mannanase having at least 60%, at least 65%, at least 70%, at least 75%, at least 80%, at least 85%, at least 90%, at least 95%, at least 98% or 100% sequence identity to SEQ ID NO: 33; and
   xi. a mannanase having at least 60%, at least 65%, at least 70%, at least 75%, at least 80%, at least 85%, at least 90%, at least 95%, at least 98% or 100% sequence identity to SEQ ID NO: 34.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 15, and preferably is obtained from Bacillus e.g. Bacillus bogoriensis.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 16, and preferably is obtained from Paenibacillus e.g. Paenibacillus woosongensis

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 17, and preferably is obtained from Paenibacillus e.g. Paenibacillus illinoisensis.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 18, and preferably is obtained from Neobulgaria sp.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID

NO: 19, and preferably is obtained from Preussia e.g. Preussia aemulans.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 20, and preferably is obtained from Yunnania e.g. Yunnania penicillate.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 21, and preferably is obtained from Myrothecium e.g. Myrothecium roridum.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 22, and preferably is obtained from Chaetomium e.g. Chaetomium Brasiliense.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 23, and preferably is obtained from Ascobolus e.g. Ascobolus stictoideus.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 24, and preferably is obtained from Chaetomium e.g. Chaetomium virescens.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 33, and preferably is obtained from Paenibacillus.

One embodiment relates to an enzyme composition e.g. a cleaning composition comprising a DNase, a mannanase, and a cleaning adjunct, preferably comprising a surfactant, wherein the DNase has at least 60%, at least 65%, at least 70%, at least 75%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1 sequence identity to the amino acid sequence shown in SEQ ID NO: 1 with the proviso that the DNase is not the DNase shown in SEQ ID NO: 36 and wherein the mannanase has at least 60%, at least 65%, at least 70%, at least 75%, at least 80%, at least 85%, at least 90%, at least 95%, at least 98% or 100% sequence identity to SEQ ID NO: 34, and preferably is obtained from Bacillus e.g. Bacillus hemicellulosilyticus.

Protease

One preferred enzyme to be combined with the DNase enzyme is a protease. Proteases are enzymes that hydrolyze peptide bonds. The most frequently used protease for household care segment is the serine proteases (or serine endopeptidases), E.C. 3.4.21, which are enzymes that cleave peptide bonds in proteins, in which serine serves as the nucleophilic amino acid at the active site. Suitable proteases include those of bacterial, fungal, plant, viral or animal origin e.g. vegetable or microbial origin. Microbial origin is preferred. Preferably the protease is a subtilase and even more preferably the protease belongs to the subtilisin sub group of subtilases. Most of the proteases used in the cleaning industry today are obtained from Bacillus e.g. Bacillus lentus and Bacillus amyloliquefaciens. One embodiment of the invention relates to an enzyme composition e.g. a cleaning composition comprising a DNase, a protease and preferably at least one cleaning adjunct, wherein the protease is obtained from Bacillus preferably from Bacillus lentus, Bacillus amyloliquefaciens, Bacillus gibsonii, Bacillus licheniformis, Bacillus pumilus, Bacillus halodurans or Bacillus subtilis.

One embodiment relates to a an enzyme composition e.g. cleaning composition comprising a DNase, a protease, and a cleaning adjunct, preferably comprising a surfactant, wherein the DNase has at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, wherein the protease belongs to E.C. 3.4.21.

One embodiment relates to an enzyme composition e.g. a cleaning composition comprising a DNase, a protease, and a cleaning adjunct, preferably comprising a surfactant, wherein the DNase has at least 60%, at least 65%, at least 70%, at least 75%, at least 80%, at least 85%, at least 90%, at least 95%, at least 98% or 100% sequence identity to the amino acid sequence shown in SEQ ID NO: 1, wherein the protease is obtained from Bacillus preferably from Bacillus lentus, Bacillus amyloliquefaciens, Bacillus licheniformis, Bacillus pumilus, Bacillus halodurans or Bacillus subtilis.

One embodiment relates to an enzyme composition e.g. a cleaning composition comprising a DNase, a protease, and a cleaning adjunct, preferably comprising a surfactant, wherein the DNase has at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the amino acid sequence shown in SEQ ID NO: 1, and wherein the protease is selected from the group consisting of;
a) a protease having at least 60%, at least 65%, at least 70%, at least 75%, at least 80%, at least 85%, at least 90%, at least 95%, at least 98%, at least 99% or 100% sequence identity to SEQ ID NO: 25, preferably obtained from Bacillus lentus;
b) a protease having at least 60%, at least 65%, at least 70%, at least 75%, at least 80%, at least 85%, at least 90%, at least 95%, at least 98%, at least 99% or 100% sequence identity to SEQ ID NO: 26; preferably obtained from Bacillus amyloliquefaciens;
c) a protease having at least 60%, at least 65%, at least 70%, at least 75%, at least 80%, at least 85%, at least 90%, at least 95%, at least 98%, at least 99% or 100% sequence identity to SEQ ID NO: 27, preferably obtained from Bacillus sp.;
d) a protease having at least 60%, at least 65%, at least 70%, at least 75%, at least 80%, at least 85%, at least 90%, at least 95%, at least 98%, at least 99% or 100% sequence identity to SEQ ID NO: 28, preferably obtained from Bacillus gibsonii;
e) a protease having at least 60%, at least 65%, at least 70%, at least 75%, at least 80%, at least 85%, at least 90%, at least 95%, at least 98%, at least 99% or 100% sequence identity to SEQ ID NO: 29, preferably obtained from Bacillus lentus;
f) a protease having at least 60%, at least 65%, at least 70%, at least 75%, at least 80%, at least 85%, at least 90%, at least 95%, at least 98%, at least 99% or 100% sequence identity to SEQ ID NO: 30, preferably obtained from Bacillus licheniformis;
g) or a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises the substitution T22R or T22A compared to SEQ ID NO: 25, wherein the position corresponds to the position of SEQ ID NO: 25;
h) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises one or more, preferably all the substitutions selected from the group consisting of: S3T, V41, A188P and V199I, compared to SEQ ID NO: 25, wherein the positions correspond to the positions of SEQ ID NO: 25;
i) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises one or more, preferably all the substitutions selected from the group consisting of N114L, T207A, A226V, and E265F, compared to SEQ ID NO: 25, wherein the positions correspond to the positions of SEQ ID NO: 25;
j) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises one or more, preferably all substitutions selected from the group consisting of: S97D, S101A, V1021 and G157S compared to SEQ ID NO: 25, wherein the positions correspond to the positions of SEQ ID NO: 25;
k) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises one or more, preferably all the substitutions selected from the group consisting of: S85N, G116V, S126L, P127Q and S128A compared to SEQ ID NO: 25, wherein the positions correspond to the positions of SEQ ID NO: 25;
l) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises one or more, preferably all the substitutions selected from the group consisting of: Y161A, R164S and A188P, compared to SEQ ID NO: 25, wherein the positions correspond to the positions of SEQ ID NO: 25;
m) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises one or more, preferably all the substitutions selected from the group consisting of: S3T, R19L, and A188P, wherein the positions correspond to the positions of SEQ ID NO: 25;
n) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises one or more, preferably all the substitutions selected from the group consisting of: S9R, R19L, and N60D, wherein the positions correspond to the positions of SEQ ID NO: 25; o) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises the amino acid Arginine (R), at a position corresponding to a position selected from the group consisting of: 9, 42 and 239 of SEQ ID NO: 25;
p) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises the amino acid Glutamic acid (E) or Aspartic acid (D), at a position corresponding to a position selected from the group consisting of: 9, 42, 60, 61, 74, 157, 176, 179, 182, 212, 250, 253 and 256 of SEQ ID NO: 25;
q) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises an insertion of the amino acid Aspartic acid (D) or Glutamic acid (E) at a position corresponding to position 97 of SEQ ID NO: 25;
r) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises the amino acid selected from the group consisting of: Glutamic acid (E), Aspartic acid (D), Glycine (G), Arginine (R) and Methionine (M) at a position corresponding to position 99 of SEQ ID NO: 25;
s) a protease having at least 60%, at least 65%, at least 70%, at least 75%, at least 80%, at least 85%, at least 90%, at least 95%, at least 98% but less than 100% sequence identity to SEQ ID NO: 25, wherein the protease comprises the amino acid selected from the group consisting of: Glutamic acid (E), Aspartic acid (D) and Glutamine (Q), at a position corresponding to position 211 of SEQ ID NO: 25;
t) a protease having at least 60%, at least 65%, at least 70%, at least 75%, at least 80%, at least 85%, at least 90%, at least 95%, at least 98% but less than 100% sequence identity to SEQ ID NO: 26, wherein the protease comprises the amino acid selected from the group consisting of: Glutamic acid (E), Aspartic acid (D) and Glutamine (Q), at a position corresponding to position 217 of SEQ ID NO: 26; and
u) a protease having at least 60%, at least 65%, at least 70%, at least 75%, at least 80%, at least 85%, at least 90%, at least 95%, at least 98% but less than 100% sequence identity to SEQ ID NO: 26, wherein the protease comprises one or more of the substitutions selected from the group consisting of: S24G/R, S53G, S78N, S101N, G128A/S and Y217Q/L, compared to SEQ ID NO: 26, wherein the positions correspond to the positions of SEQ ID NO: 26.

A particularly preferred composition according to the invention comprises DNase, and the additional enzyme comprises mannanase and amylase, as described above.

### Cleaning Adjunct

The cleaning compositions, in addition to the DNase enzyme and additional enzyme, comprise a cleaning/detergent adjunct, preferably comprising a surfactant. The expression cleaning adjunct herein typically comprises a combination of more than one cleaning adjunct. Typically the cleaning adjunct will be present in the composition in an amount from 0.0001 to 99.9999 wt %, preferably from 10 to 99.999 wt %, preferably at least 30 or 40 or 50 wt % cleaning adjunct. Suitable cleaning adjuncts comprise: surfactants, builders, bleaches, bleach catalysts, colorants, bleach boosters, chelating agents, dye transfer agents, deposition aids, dispersants, further additional enzymes, and enzyme stabilizers, catalytic materials, bleach activators, hydrogen peroxide, sources of hydrogen peroxide, optical brighteners, photoactivators, fluorescers, fabric hueing agents, fabric conditioners, preformed peracids, polymeric dispersing agents, clay soil removal/anti-redeposition agents, filler salts, hydrotropes, brighteners, suds suppressors, structure elasticizing agents, fabric softeners, hydrolyzable surfactants, preservatives, anti-oxidants, anti-shrinkage agents, germicides, fungicides, anti-tarnish, anti-corrosion agents, alkalinity sources, solubilizing agents, carriers, processing aids, pigments, dyes, perfumes and pH control agents, encapsulates, polymers and mixtures thereof. For example, these may include: bleach ingredients such as imine bleach boosters; sources of hydrogen peroxide such as percarbonate and/or perborate, especially percarbonate coated with material such as carbonate and/or sulphate salt, silicate salt, borosilicate, and any mixture thereof; pre-formed peracid, including pre-formed peracid in encapsulated form;

transition metal catalysts; suds suppressors or suppressor systems such as silicone based suds suppressors and/or fatty acid based suds suppressors; fabric-softeners such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters; carboxylate polymers such as maleic acid polymers or co-polymers of maleic and acrylic acid; perfumes such as perfume microcapsules, starch encapsulated accords, perfume spray-on; soap rings; aesthetic particles; dyes; fillers such as sodium sulphate and/or citrus fibres, although it may be preferred for the composition to be substantially free of fillers; silicate salt such as sodium silicate, including 1.6R and 2.0R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose; solvents such as 1,2 propanediol, monoethanolamine; diethylene glycol, ethanol, and any mixture thereof; hydrotropes such as sodium cumene sulphonate, sodium xylene sulphonate, sodium toluene sulphonate, and any mixtures; organic acids such as citric acid; and any combination thereof. Preferably the composition comprises a cleaning adjunct comprising surfactant and additional enzyme. Preferably the composition comprises one or more adjuncts selected from the group consisting of (i) perfume microcapsule; (ii) fabric hueing agent; (iii) protease; (iv) amphiphilic cleaning polymer; (v) RNase, (viii) xanthan lyase; (ix) hexosaminidase; or (viii) mixtures thereof.

Preferably the composition comprises a surfactant, preferably from 0.1 to 60 weight % or from 0.5 to 50 wt % or 1 to 40 wt % of the composition, surfactant. The surfactant preferably comprises a surfactant system comprising a mixture of more than one surfactant, which may comprise for example, anionic, non-ionic including semi-polar, cationic, zwitterionic and/or amphoteric surfactants and mixtures thereof. Preferably the composition comprises an amine oxide.

Preferably the composition comprises an anionic surfactant. Preferred anionic surfactants are sulfonate and sulfate surfactants, preferably alkylbenzene sulphonates and/or (optionally alkoxylated) alkyl sulfates. Particularly preferred anionic surfactant comprises linear alkylbenzenesulfonates (LAS). Preferred alkyl sulfates comprise alkyl ether sulfates, especially C-9-15 alcohol ether sulfates, especially those having an average degree of ethoxylation from 0.5 to 7, preferably from 1 to 5, C₈-C₁₆ ester sulfates and C₁₀-C₁₄ ester sulfates, such as mono dodecyl ester sulfates. In a preferred composition according to the invention the surfactant comprises anionic surfactant, preferably comprising alkyl benzene sulphonate and/or optionally ethoxylated alkyl sulfate, preferably having a degree of ethoxylation from 0 to 7, more preferably from 0.5 to 3. Isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ether sulfates (AES or AEOS or FES, also known as alcohol ethoxy sulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof are also suitable anionic surfactants. In a preferred embodiment the surfactant comprises anionic surfactant, preferably comprising alkyl benzene sulphonate and/or optionally ethoxylated alkyl sulfate, preferably having a degree of ethoxylation from 0 to 7, more preferably from 0.5 to 3.

The anionic surfactants are preferably added to the cleaning composition in the form of salts. Preferred cations are alkali metal ions, such as sodium and potassium. However, the salt form of the anionic surfactant may be formed in situ by neutralization of the acid form of the surfactant with alkali such as sodium hydroxide or an amine, such as mono-, di-, or tri-ethanolamine. Preferably the surfactant comprises non-ionic surfactant. Preferably the surfactant comprises an anionic and a nonionic surfactant, preferably in a weight ratio of anionic to nonionic of from 50:1 or 30:1 to 1:2, or 1:1, preferably from 20:1 to 2:3 or 1:1.

Non-limiting examples of nonionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof. Alcohol ethoxylates are particularly preferred, preferably having a C₉-18 alkyl chain, preferably from C₁₂-15 and preferably having an average degree of ethoxylation 3 to 9, more preferably from 3 to 7. Commercially available nonionic surfactants include Plurafac™, Lutensol™ and Pluronic™ from BASF, Dehypon™ series from Cognis and Genapol™ series from Clariant.

The cleaning composition preferably comprises from about 1% to about 40% of an anionic surfactant. The cleaning composition preferably comprises from 0.2% to about 40% of a non-ionic surfactant such as alcohol ethoxylate, nonyl-phenol ethoxylate, alkylpolyglycoside, alkyldimethylamine-oxide, ethoxylated fatty acid monoethanol-amide, fatty acid monoethanolamide, polyhydroxy alkyl fatty acid amide, or N-acyl N-alkyl derivatives of glucosamine (“glucamides”).

The cleaning composition preferably comprises one or more further additional enzymes. Therefore a preferred composition comprises (a) DNase as defined herein, and (b) one or more additional enzymes selected from the group consisting of amylases, cellulases, lipases, mannanases, proteases and mixtures thereof; and one or more further additional enzyme preferably selected from the group consisting of carboxypeptidases, catalases, chitinases, cyclodextrin glycosyltransferases, deoxyribonucleases, alpha-galactosidases, beta-galactosidases, haloperoxidases, haloperoxygenases, hexosaminidases, invertases, laccases, licheninases, mannosidases, oxidases, pectinases, pectin lyases, pectinolytic enzymes, peptidoglutaminases, peroxidases, phytases, polyphenoloxidases, peroxidases, ribonucleases, transglutaminases, xylanases, xanthan lyases, xanthanases, xyloglucanases and mixtures thereof. Preferably the composition comprises further additional enzymes selected from xanthan lyases, xanthanases, and mixtures thereof. Xanthan lyase and xanthanase and mixtures thereof are also particularly preferred. The further additional enzyme(s) may be produced, for example, by a microorganism belonging to the genus Aspergillus, e.g., Aspergillus aculeatus, Aspergillus awamori, Aspergillus foetidus, Aspergillus fumigatus, Aspergillus japonicus, Aspergillus nidulans, Aspergillus niger, or Aspergillus oryzae; Fusarium, e.g., Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sulphureum, Fusarium toruloseum, Fusarium trichothecioides, or Fusarium venenatum; Humicola, e.g., Humicola insolens or Humicola lanuginosa; or Trichoderma, e.g., Trichoderma harzianum, Trichoderma koningii, Trichoderma longibrachiatum, Trichoderma reesei, or Trichoderma viride.

Preferably the composition comprises one or more, of one or more of: CGTase, pectinase, pectate lyase, and/or laccase or mixtures of more than one of these.

In general the properties of the chosen enzyme(s) should be compatible with the selected detergent, (i.e., pH-optimum, compatibility with other enzymatic and non-enzymatic ingredients, etc.), and the enzyme(s) should be present in effective amounts. Preferably, the composition of the invention comprises at least 0.01 mg, preferably from about 0.05 to about 10, more preferably from about 0.1 to about 6, especially from about 0.2 to about 5 mg of active further enzyme/ g of composition.

Peroxidases/Oxidases: Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include GUARDZYME® (Novozymes A/S).

Pectate Lyase: Other preferred enzymes include pectate lyases sold under the tradenames Pectawash®, Pectaway® (from Novozymes A/S, Bagsvaerd, Denmark).

The enzyme(s) may be included in the cleaning composition by adding separate additives (pre-mixes) containing one or more enzymes, or by adding a combined additive (pre-mix) comprising all of these enzymes. A detergent additive of the invention, i.e., a separate additive or a combined additive, can be formulated, e.g., granulate, a liquid, a slurry, etc. Preferred detergent additive formulations are granulates, in particular non-dusting granulates, liquids, in particular stabilized liquids, or slurries.

Non-dusting granulates may be produced and may optionally be coated by methods known in the art. Examples of waxy coating materials are poly(ethylene oxide) products (polyethyleneglycol, PEG) with mean molar weights of 1000 to 20000; ethoxylated nonyl-phenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Film-forming coating materials may be applied for example by fluid bed techniques. Liquid enzyme preparations may, for instance, be stabilized by adding a polyol such as propylene glycol, a sugar or sugar alcohol, lactic acid or boric acid according to established methods.

The cleaning composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof, preferred dyes are azo, especially bis azo, anthraquinone, azine and triarylmethane dyes. Azo dyes are especially preferred.

Suitable fabric hueing agents include dyes, dye-clay conjugates, and organic and inorganic pigments. Suitable dyes include small molecule dyes and polymeric dyes; polymeric dyes are preferred. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in EP1794275 or EP1794276, or dyes as disclosed in US 7,208,459 B2,and mixtures thereof. In another aspect, suitable small molecule dyes include small molecule dyes selected from the group consisting of Colour Index numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in WO2011/98355, WO2011/47987, US2012/090102, WO2010/145887, WO2006/055787 and WO2010/142503.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as

CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Preferred hueing dyes include the alkoxylated thiophene azo whitening agents, for example as described in US2008/0177090 which may be optionally anionic, such as those selected from Examples 1-42 in Table 5 of WO2011/011799. Other preferred dyes are disclosed in U.S. Pat. No. 8,138,222.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C₁-C₃ -alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule, Ultramarine Blue (C.I. Pigment Blue 29), Ultramarine Violet (C.I. Pigment Violet 15) and mixtures thereof.

Builders—The cleaning composition may further contain builders, such as builders based on carbonate, bicarbonate or silicates which may be Zeolites, such as Zeolite A, Zeolite MAP (Maximum Aluminium type P). Zeolites, useable in laundry preferably has the formula Na₁₂(AlO₂)₁₂(SiO₂)₁₂.27H₂O and the particle size is usually between 1-10 μm for zeolite A and 0.7-2 μm for zeolite MAP. Other builders are Sodium metasilicate (Na2SiO3 nH₂₀ or Na2Si2O₅. n H₂O) strong alkaline and preferably used in dish wash. In preferred embodiments, the amount of a detergent builder may be above 5%, above 10%, above 20%, above 30%, above 40% or above 50%, and may be below 80%, 65%. In a dishwash detergent, the level of builder is typically 40-65%, particularly 50-65% or even 75-90%.

Encapsulates—The composition may comprise an encapsulate. In one aspect, an encapsulate comprising a core, a shell having an inner and outer surface, said shell encapsulating said core.

In one aspect of said encapsulate, said core may comprise a material selected from the group consisting of perfumes; brighteners; dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

In one aspect of said encapsulate, said core may comprise perfume. Such encapsulates are perfume microcapsules. Suitable encapsulate shell may comprise melamine formaldehyde and/or cross linked melamine formaldehyde, and/or polyacrylate.

In one aspect, at least 75%, 85% or even 90% of said encapsulates may have a particle size of from about 1 microns to about 80 microns, about 5 microns to 60 microns, from about 10 microns to about 50 microns, or even from about 15 microns to about 40 microns.

In one aspect, at least 75%, 85% or even 90% of said encapsulates may have a particle wall thickness of from about 30 nm to about 250 nm, from about 80 nm to about 180 nm, or even from about 100 nm to about 160 nm.

In one aspect, said encapsulates' core material may comprise a material selected from the group consisting of a perfume raw material and/or optionally a material selected from the group consisting of vegetable oil, including neat and/or blended vegetable oils including caster oil, coconut oil, cottonseed oil, grape oil, rapeseed, soybean oil, corn oil, palm oil, linseed oil, safflower oil, olive oil, peanut oil, coconut oil, palm kernel oil, castor oil, lemon oil and mixtures thereof; esters of vegetable oils, esters, including dibutyl adipate, dibutyl phthalate, butyl benzyl adipate, benzyl octyl adipate, tricresyl phosphate, trioctyl phosphate and mixtures thereof straight or branched chain hydrocarbons, including those straight or branched chain hydrocarbons having a boiling point of greater than about 80 ° C.; partially hydrogenated terphenyls, dialkyl phthalates, alkyl biphenyls, including monoisopropylbiphenyl, alkylated naphthalene, including dipropylnaphthalene, petroleum spirits, including kerosene, mineral oil and mixtures thereof aromatic solvents, including benzene, toluene and mixtures thereof silicone oils; and mixtures thereof.

In one aspect, said encapsulates' wall material may comprise a suitable resin including the reaction product of an aldehyde and an amine, suitable aldehydes include, formaldehyde. Suitable amines include melamine, urea, benzoguanamine, glycoluril, and mixtures thereof. Suitable melamines include, methylol melamine, methylated methylol melamine, imino melamine and mixtures thereof. Suitable ureas include, dimethylol urea, methylated dimethylol urea, urea-resorcinol, and mixtures thereof.

In one aspect, suitable formaldehyde scavengers may be employed with the encapsulates, for example, in a capsule slurry and/or added to a consumer product before, during or after the encapsulates are added to such consumer product. Suitable capsules can be purchased from Appleton Papers Inc. of Appleton, Wisconsin USA.

In addition, the materials for making the aforementioned encapsulates can be obtained from Solutia Inc. (St Louis, Mo. U.S.A.), Cytec Industries (West Paterson, N.J. U.S.A.), sigma-Aldrich (St. Louis, Mo. U.S.A.), CP Kelco Corp. of San Diego, Calif., USA; BASF AG of Ludwigshafen, Germany; Rhodia Corp. of Cranbury, New Jersey, USA; Hercules Corp. of Wilmington, Delaware, USA; Agrium Inc. of Calgary, Alberta, Canada, ISP of New Jersey U.S.A., Akzo Nobel of Chicago, Ill., USA; Stroever Shellac Bremen of Bremen, Germany; Dow Chemical Company of Midland, Mich., USA; Bayer AG of Leverkusen, Germany; Sigma-Aldrich Corp., St. Louis, Mo., USA.

The composition may comprise a structurant selected from the group consisting of diglycerides and triglycerides, ethylene glycol di stearate microcrystalline cellulose, cellulose-based materials, microfiber cellulose, biopolymers, xanthan gum, gellan gum, and mixtures thereof.

### Polymers

The cleaning composition may comprise one or more polymers. Examples are carboxymethylcellulose, poly(vinyl-pyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers and amphiphilic polymers.

### Amphiphilic Cleaning Polymers

Preferably, the amphiphilic cleaning polymer is a compound having the following general structure: bis((C₂H₅O)(C₂H₄O)n)(CH₃)—NtCₓH₂ₓ—N³⁰(CH₃)-bis((C₂H₅O)(C₂H₄O)n), wherein n=from 20 to 30, and x=from 3 to 8, or sulphated or sulphonated variants thereof.

Amphiphilic alkoxylated grease cleaning polymers of the present invention refer to any alkoxylated polymer having balanced hydrophilic and hydrophobic properties such that they remove grease particles from fabrics and surfaces. Specific embodiments of the amphiphilic alkoxylated grease cleaning polymers of the present invention comprise a core structure and a plurality of alkoxylate groups attached to that core structure. These may comprise alkoxylated polyalkylenimines, preferably having an inner polyethylene oxide block and an outer polypropylene oxide block.

The core structure may comprise a polyalkylenimine structure comprising, in condensed form, repeating units of formulae (I), (II), (III) and (IV):

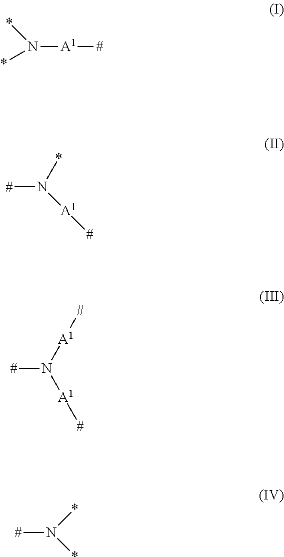

wherein # in each case denotes one-half of a bond between a nitrogen atom and the free binding position of a group A¹ of two adjacent repeating units of formulae (I), (II), (III) or (IV); * in each case denotes one-half of a bond to one of the alkoxylate groups; and A¹ is independently selected from linear or branched C₂-C₆-alkylene; wherein the polyalkylenimine structure consists of 1 repeating unit of formula (I), x repeating units of formula (II), y repeating units of formula (III) and y+1 repeating units of formula (IV), wherein x and y in each case have a value in the range of from 0 to about 150; where the average weight average molecular weight, Mw, of the polyalkylenimine core structure is a value in the range of from about 60 to about 10,000 g/mol.

The core structure may alternatively comprise a polyalkanolamine structure of the condensation products of at least one compound selected from N-(hydroxyalkyl)amines of formulae (La) and/or (Lb),

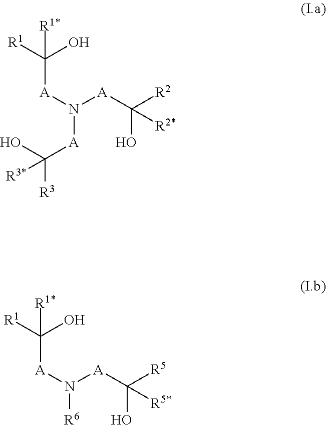

wherein A are independently selected from C₁-C₆-alkylene; R¹, R¹*, R², R²*, R³, R³*, R⁴, R⁴*, R⁵ and R⁵* are independently selected from hydrogen, alkyl, cycloalkyl or aryl, wherein the last three mentioned radicals may be optionally substituted; and R⁶ is selected from hydrogen, alkyl, cycloalkyl or aryl, wherein the last three mentioned radicals may be optionally substituted.

The plurality of alkylenoxy groups attached to the core structure are independently selected from alkylenoxy units of the formula (V)

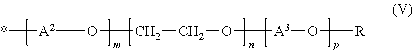

wherein * in each case denotes one-half of a bond to the nitrogen atom of the repeating unit of formula (I), (II) or (IV); A² is in each case independently selected from 1,2-propylene, 1,2-butylene and 1,2-isobutylene; A³ is 1,2-propylene; R is in each case independently selected from hydrogen and C₁-C₄-alkyl; m has an average value in the range of from 0 to about 2; n has an average value in the range of from about 20 to about 50; and p has an average value in the range of from about 10 to about 50.

Specific embodiments of the amphiphilic alkoxylated grease cleaning polymers may be selected from alkoxylated polyalkylenimines having an inner polyethylene oxide block and an outer polypropylene oxide block, the degree of ethoxylation and the degree of propoxylation not going above or below specific limiting values. The alkoxylated polyalkylenimines preferably have a minimum ratio of polyethylene blocks to polypropylene blocks (n/p) of about 0.6 and a maximum of about 1.5(x+2y+1)^{1/2}. Alkoxykated polyalkyenimines having an n/p ratio of from about 0.8 to about 1.2(x+2y+1)^{1/2} have been found to have especially beneficial properties. The alkoxylated polyalkylenimines may have a backbone which consists of primary, secondary and tertiary amine nitrogen atoms which are attached to one another by alkylene radicals A and are randomly arranged. Primary amino moieties which start or terminate the main chain and the side chains of the polyalkylenimine backbone and whose remaining hydrogen atoms are subsequently replaced by alkylenoxy units are referred to as repeating units of formulae (I) or (IV), respectively. Secondary amino moieties whose remaining hydrogen atom is subsequently replaced by alkylenoxy units are referred to as repeating units of formula (II). Tertiary amino moieties which branch the main chain and the side chains are referred to as repeating units of formula (III).

The polyalkylenimine backbone consisting of the nitrogen atoms and the A groups, preferably has an average molecular weight Mw of from about 60 to about 10,000 g/mole, preferably from about 100 to about 8,000 g/mole and more preferably from about 500 to about 6,000 g/mole.

The sum (x+2y+1) corresponds to the total number of alkylenimine units present in one individual polyalkylenimine backbone and thus is directly related to the molecular weight of the polyalkylenimine backbone. The values given in the specification however relate to the number average of all polyalkylenimines present in the mixture. The sum (x+2y+2) corresponds to the total number amino groups present in one individual polyalkylenimine backbone. The radicals A connecting the amino nitrogen atoms may be identical or different, linear or branched C₂-C₆-alkylene radicals, such as 1,2-ethylene, 1,2-propylene, 1,2-butylene, 1,2-isobutylene, 1,2-pentanediyl, 1,2-hexanediyl or hexamethylen. A preferred branched alkylene is 1,2-propylene. Preferred linear alkylene are ethylene and hexamethylene. A more preferred alkylene is 1,2-ethylene.

The hydrogen atoms of the primary and secondary amino groups of the polyalkylenimine backbone are replaced by alkylenoxy units of the formula (V).

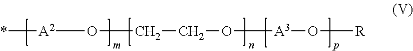

In this formula, the variables preferably have one of the meanings given below:

A² in each case is selected from 1,2-propylene, 1,2-butylene and 1,2-isobutylene; preferably A² is 1,2-propylene. A³ is 1,2-propylene; R in each case is selected from hydrogen and C₁-C₄-alkyl, such as methyl, ethyl, n-propyl, isopropyl, n-butyl, isobutyl and tert.-butyl; preferably R is hydrogen. The index m in each case has a value of 0 to about 2; preferably m is 0 or approximately 1; more preferably m is 0. The index n has an average value in the range of from about 20 to about 50, preferably in the range of from about 22 to about 40, and more preferably in the range of from about 24 to about 30. The index p has an average value in the range of from about 10 to about 50, preferably in the range of from about 11 to about 40, and more preferably in the range of from about 12 to about 30. Preferably the alkylenoxy unit of formula (V) is a non-random sequence of alkoxylate blocks. By non-random sequence it is meant that the [-A²-O-]m is added first (i.e., closest to the bond to the nitrgen atom of the repeating unit of formula (I), (II), or (III)), the [—CH₂—CH₂—O—]ₙ is added second, and the [-A³-O-]ₚ is added third. This orientation provides the alkoxylated polyalkylenimine with an inner polyethylene oxide block and an outer polypropylene oxide block. The substantial part of these alkylenoxy units of formula (V) is formed by the ethylenoxy units -[CH₂—CH₂—O)ₙ]- and the propylenoxy units —[CH₂—CH₂(CH₃)—O]ₚ-. The alkylenoxy units may additionally also have a small proportion of propylenoxy or butylenoxy units -[A²-O]ₘ-, i.e. the polyalkylenimine backbone saturated with hydrogen atoms may be reacted initially with small amounts of up to about 2 mol, especially from about 0.5 to about 1.5 mol, in particular from about 0.8 to about 1.2 mol, of propylene oxide or butylene oxide per mole of NH-moieties present, i.e. incipiently alkoxylated.

The amphiphilic alkoxylated grease cleaning polymers are preferably present in the cleaning compositions of the present invention at levels ranging from about 0.05% to 10% by weight of the fabric and home care product. Embodiments of the fabric and home care products may comprise from about 0.1% to about 5% by weight. More specifically, the embodiments may comprise from about 0.25 to about 2.5% of the grease cleaning polymer.

Carboxylate polymer—The cleaning compositions of the present invention may also include one or more carboxylate polymers such as a maleate/acrylate random copolymer or polyacrylate homopolymer. In one aspect, the carboxylate polymer is a polyacrylate homopolymer having a molecular weight of from 4,000 Da to 9,000 Da, or from 6,000 Da to 9,000 Da.

Soil release polymer—The cleaning compositions of the present invention may also include one or more soil release polymers having a structure as defined by one of the following structures (I), (II) or (III):

(I) —[(OCHR¹—CHR²)ₐ—O—OC—Ar—CO—]_{d}

(II) —[(OCHR³—CHR⁴)_{b}—O—OC-sAr-CO—]ₑ

(III) —[(OCHR⁵—CHR⁶)_{c}—OR⁷]_{f}

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

Cellulosic polymer—The cleaning compositions of the present invention may also include one or more cellulosic polymers including those selected from alkyl cellulose, alkyl alkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixures thereof. In one aspect, the carboxymethyl cellulose has a degree of carboxymethyl substitution from 0.5 to 0.9 and a molecular weight from 100,000 Da to 300,000 Da.

The detergent may contain a bleaching system, which may comprise a H₂O₂ source such as perborate or percarbonate which may be combined with a peracid-forming bleach activator such as tetraacetylethylenediamine or nonanoyloxybenzenesulfonate. Alternatively, the bleaching system may comprise peroxyacids of, e.g., the amide, imide, or sulfone type. In general, when a bleaching agent is used, the compositions of the present invention may comprise from about 0.1% to about 50% or even from about 0.1% to about 25% bleaching agent by weight of the subject cleaning composition.

Chelating Agents—The cleaning compositions herein may contain a chelating agent. Suitable chelating agents include copper, iron and/or manganese chelating agents and mixtures thereof. When a chelating agent is used, the subject cleaning composition may comprise from about 0.005% to about 15% or even from about 3.0% to about 10% chelating agent by weight of the subject cleaning composition. Suitable chelants include DTPA (Diethylene triamine pentaacetic acid), HEDP (Hydroxyethane diphosphonic acid), DTPMP (Diethylene triamine penta(methylene phosphonic acid)), 1,2-Dihydroxybenzene-3,5-disulfonic acid disodium salt hydrate, ethylenediamine, diethylene triamine, ethylenediaminedisuccinic acid (EDDS), N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof.

The enzyme variants of the invention may be stabilized using conventional stabilizing agents, and/or protease inhibitors e.g., a polyol such as propylene glycol or glycerol, a sugar or sugar alcohol, salts such as sodium chloride and potassium chloride, lactic acid, formic acid, boric acid, or a boric acid derivative, e.g., an aromatic borate ester, or a phenyl boronic acid derivative such as 4-formylphenyl boronic acid, or a peptide aldehyde such as di-, tri- or tetrapeptide aldehydes or aldehyde analogues (either of the form B 1-B0-R wherein, R is H, CH₃, CX₃, CHX₂, or CH₂X (X═halogen), B0 is a single amino acid residue (preferably with an optionally substituted aliphatic or aromatic side chain); and B1 consists of one or more amino acid residues (preferably one, two or three), optionally comprising an N-terminal protection group, or as described in WO09118375, WO98/13459) or a protease inhibitor of the protein type such as RASI, BASI, WASI (bifunctional alpha-amylase/subtilisin inhibitors of rice, barley and wheat) or CI2 or SSI. In some embodiments, the enzymes employed herein are stabilized by the presence of water-soluble sources of zinc (II), calcium (II) and/or magnesium (II) ions in the finished compositions that provide such ions to the enzymes, as well as other metal ions (e.g., barium (II), scandium (II), iron (II), manganese (II), aluminum (III), Tin (II), cobalt (II), copper (II), Nickel (II), and oxovanadium (IV)).

The composition may comprise an enzyme stabilizer selected from the group consisting of (a) inorganic salts selected from the group consisting of calcium salts, magnesium salts and mixtures thereof; (b) carbohydrates selected from the group consisting of oligosaccharides, polysaccharides and mixtures thereof; (c) mass efficient reversible protease inhibitors selected from the group consisting of phenyl boronic acid and derivatives thereof; and (d) mixtures thereof.

The composition may comprise: (1) reversible protease inhibitors such as a boron containing compound; (2) 1-2 propane diol; (3) calcium formate and/or sodium formate; and (4) any combination thereof.

The cleaning composition may also contain (as cleaning adjunct) other conventional detergent ingredients such as e.g. fabric conditioners including clays, foam boosters, suds suppressors, anti-corrosion agents, soil-suspending agents, anti-soil re-deposition agents, dyes, bactericides, optical brighteners, hydrotropes, tarnish inhibitors, organic solvents such as ethanol or perfumes. Furthermore, the cleaning composition could contain a pre-spotter or a booster, which is added to the wash to increase the general cleaning level, some of these additives may also be used as a pre-treatment agent applied to the textile before the washing step.

It is at present contemplated that in the cleaning compositions any enzyme, in particular the enzymes essential to the present invention, may be added in an amount corresponding to 0.001-100 mg of enzyme protein per liter of wash liquor, preferably 0.005-5 mg of enzyme protein per liter of wash liquor, more preferably 0.01-1 mg of enzyme protein per liter of wash liquor and in particular 0.1-1 mg of enzyme protein per liter of wash liquor. However, the compositions of the present invention comprise at least 0.0001 to about 0.1% weight percent of pure enzyme protein, such as from about 0.0001% to about 0.01%, from about 0.001% to about 0.01% or from about 0.001% to about 0.01%. However, when using a formulated enzyme the cleaning composition comprises from about 0.02% to about 20% weight percent, such as or from about 0.05% to about 15% weight, or from about 0.05 to about 20%, or from about 0.05% to about 5%, or from about 0.05% to about 3%.

### Method of Use

The present invention includes a method for cleaning and/or treating a surface, preferably a fabric. In one aspect, such method comprises the steps of optionally washing and/or rinsing said surface, contacting said surface with an aqueous wash liquor comprising the cleaning composition described herein, then optionally washing and/or rinsing said surface.

The aqueous wash liquor preferably has a pH of from about 4 or from about 7 or 8 to about 12, preferably to about 10.5. The compositions are preferably employed at concentrations of from about 500 ppm to about 15,000 ppm in solution. The water temperatures typically range from about 5 ° C. to about 90 ° C. The water to fabric ratio is typically from about 1:1 to about 30:1. The present invention also provides use of a cleaning composition of the invention to provide an improved wash performance in detergent applications, such as dish wash or laundering at low temperatures.

In a further aspect, the invention relates to a method for removing a stain from a surface comprising contacting the surface with an hybrid polypeptide or amylases variant as described herein, and a cleaning adjunct, wherein the cleaning adjunct comprises surfactant and optionally one or more cleaning adjunct selected from the list comprising of hydrotropes, builders and co-builders, bleaching systems, polymers, fabric hueing agents and adjunct materials, or any mixture thereof in detergent compositions and in detergent applications. A further aspect is a method for removing a stain from a surface comprising contacting the surface with a cleaning composition as described herein.

The present invention is further described by the following examples that should not be construed as limiting the scope of the invention.

### EXAMPLES

### Assays

Assay I: Testing of DNase Activity

DNase activity is determined on DNase Test Agar with Methyl Green (BD, Franklin Lakes, NJ, USA), which is prepared according to the manual from supplier. Briefly, 21 g of agar is dissolved in 500 ml water and then autoclaved for 15 min at 121° C. Autoclaved agar is temperated to 48° C. in water bath, and 20 ml of agar is poured into petri dishes with and allowed to solidify by incubation o/n at room temperature. On solidified agar plates, 5 μl of enzyme solutions are added and DNase activity is observed as colorless zones around the spotted enzyme solutions

Assay II: Testing of DNase Activity

DNase activity is determined by using the DNaseAlertTM Kit (11-02-01-04, IDT Intergrated DNA Technologies) according to the supplier's manual. Briefly, 95 μl DNase sample is mixed with 5μl substrate in a microtiter plate, and fluorescence is immediately measured using a Clariostar microtiter reader from BMG Labtech (536 nm excitation, 556 nm emission).

Assay III: Testing of Alpha-Amylase Activity

The alpha-amylase activity may be determined by a method employing the G7-pNP substrate. G7-pNP which is an abbreviation for 4,6-ethylidene(G₇)-p-nitrophenyl(G₁)-α,D-maltoheptaoside, a blocked oligosaccharide which can be cleaved by an endo-amylase, such as an alpha-amylase. Following the cleavage, the alpha-Glucosidase included in the kit digest the hydrolysed substrate further to liberate a free PNP molecule which has a yellow color and thus can be measured by visible spectophometry at λ=405 nm (400-420 nm.). Kits containing G7-pNP substrate and alpha-Glucosidase is manufactured by Roche/Hitachi (cat. No.11876473). The G7-pNP substrate from this kit contains 22 mM 4,6-ethylidene-G7-pNP and 52.4 mM HEPES (2-[4-(2-hydroxyethyl)-1-piperazinyl]-ethanesulfonic acid), pH 7.0). The alpha-Glucosidase reagent contains 52.4 mM HEPES, 87 mM NaCl, 12.6 mM MgCl₂, 0.075 mM CaCl₂, ≥4 kU/L alpha-glucosidase). The substrate working solution is made by mixing 1 mL of the alpha-Glucosidase reagent with 0.2 mL of the G7-pNP substrate. This substrate working solution is made immediately before use. Dilution buffer: 50 mM MOPS, 0.05% (w/v) Triton X100 (polyethylene glycol p-(1,1,3,3-tetramethylbutyl)-phenyl ether (C₁₄H₂₂O(C₂H₄O)ₙ(n=9-10))), 1 mM CaCl₂, pH_{8.0.} The amylase sample to be analyzed is diluted in dilution buffer to ensure the pH in the diluted sample is 7. The assay is performed by transferring 20 μl diluted enzyme samples to 96 well microtiter plate and adding 80μ1 substrate working solution. The solution is mixed and pre-incubated 1 minute at room temperature and absorption is measured every 20 sec. over 5 minutes at OD 405 nm. The slope (absorbance per minute) of the time dependent absorption-curve is directly proportional to the specific activity (activity per mg enzyme) of the alpha-amylase in question under the given set of conditions. The amylase sample should be diluted to a level where the slope is below 0.4 absorbance units per minute.

Assay IV: Testing of Cellulase Activity

An AZCL-He-cellulose (azurine dye covalently cross-linked cellulose) assay is used for detection of cellulase (endo-glucanase) activity. AZCL-He-cellulose (75 mg) is suspended in 15 mL detergent (e.g. Model detergent A). To 1 mL of this solution in Eppendorf tubes is added 100 μL enzyme (0.09 mg enzyme protein/mL), incubated for 15 min at 40° C. while shaking at 1250 rpm in a pre-heated thermo mixer and spun down for 2 min at 13200 rpm. 250 μL of the solution is transferred to a micro-titer plate and the sample absorbance is measured at 590 nm.

Assay V: Testing of Lipase Activity

Lipase is diluted with a buffer (10 mM Succinic acid+2 mM CaCl₂+0.02% Brij 35 adjusted to pH_{6.5}) to the specified concentration. 10 uL of the 100 ppm lipase solution is added to a 90uL of detergent composition, stirred for 5 minutes and sealed. Samples are stored at 4° C. in detergent D002 (unstressed) and in detergent D002 at 47° C. (stressed). Storage time is 335.5 hours.

After storage possible condensation liquid is collected by centrifugation. To the 100 μL stressed or unstressed sample 235 uL of buffer (0.1M Tris-HCl, 9 mM CaCl₂, 0.0225% Brij-30, pH_{8.0+0.85}% 4-FBPA (31.5g/1)) are added corresponding to a 3.35-fold dilution. After 10 minutes stirring 5 uL sample aliquots are further diluted with the same buffer 60-fold. Then one part of this lipase dilution is mixed with four parts of 0.5 mM pNP-palmitate, 1mM calcium chloride, 100 mM Tris (pH_{8.0}), 6.5 mM Deoxycholate, 1.4 g/L AOS and for 30 minutes release of the pNP chromophore is measured spectrophotometrically. This is used to determine activity via the initial linear slope of the reaction. Residual activity is calculated as the ratio of the measured velocities of stressed versus unstressed sample. The median value of the residual activity is calculated based on four replicates and normalized by a lipase variant reference run with each experimental set.

Assay VI: Testing of Mannanase Activity

Mannanase activity may be tested according to standard test procedures known in the art, such as by applying a solution to be tested to 4 mm diameter holes punched out in agar plates containing 0.2% AZCL galactomannan (carob), i.e. substrate for the assay of endo-1,4-beta-D-mannanase available as CatNo.I-AZGMA from the company Megazyme (Megazyme's Internet address: http://www.megazyme.com/Purchase/index.html).

Assay VII: Testing of Protease Activity

Proteolytic activity can be determined by a method employing Suc-AAPF-PNA as the substrate. Suc-AAPF-PNA is an abbreviation for N-Succinyl-Alanine-Alanine-Proline-Phenylalanine-p-Nitroanilide and is a blocked peptide which can be cleaved by endo-proteases. Following cleavage, a free PNA molecule is liberated, which has a yellow color and thus can be measured by visible spectrophotometry at wavelength 405 nm. The Suc-AAPF-PNA substrate is manufactured by Bachem (cat. no. L1400, dissolved in DMSO). The protease sample to be analyzed is diluted in residual activity buffer (100 mM Tris pH 8.6). The assay is performed by transferring 3 μl of diluted enzyme samples to 96 well microtiter plate and adding 70 μl substrate working solution (0.72 mg/ml in 100 mM Tris pH_{8.6}). The solution is mixed at room temperature and absorption is measured every 20 seconds over 5 minutes at OD 405 nm. The slope (absorbance per minute) of the time dependent absorption-curve is directly proportional to the activity of the protease in question under the given set of conditions. The protease sample is diluted to a level where the slope is linear.

### Cleaning Composition Examples

### Examples 1-6

Granular laundry detergent compositions designed for hand washing or top-loading washing machines.

| | 1 | 2 | 3 | 4 | 5 | 6 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 0.2 | 1 | 0.6 | 0.0 | 0 |
| ammonium chloride | | | | | | |
| AE3S | 0.9 | 1 | 0.9 | 0.0 | 0.5 | 0.9 |
| AE7 | 0.0 | 0.0 | 0.0 | 1 | 0.0 | 3 |
| Sodium tripolyphosphate | 5 | 0.0 | 4 | 9 | 2 | 0.0 |
| Zeolite A | 0.0 | 1 | 0.0 | 1 | 4 | 1 |
| 1.6R Silicate (SiO₂:Na₂O at | 7 | 5 | 2 | 3 | 3 | 5 |
| ratio 1.6:1) | | | | | | |
| Sodium carbonate | 25 | 20 | 25 | 17 | 18 | 19 |
| Polyacrylate MW 4500 | 1 | 0.6 | 1 | 1 | 1.5 | 1 |
| Random graft copolymer¹ | 0.1 | 0.2 | 0.0 | 0.0 | 0.0 | 0.0 |
| Carboxymethyl cellulose | 1 | 0.3 | 1 | 1 | 1 | 1 |
| Protease as described herein | | | | | | |
| (e.g. Savinase ®, 32.89 mg | 0.1 | 0.1 | 0.1 | 0.1 | — | 0.1 |
| active/g) | | | | | | |
| Cellulase as described herein | 0.15 | 0.2 | 0.4 | 0.3 | — | 0.1 |
| (20 mg active/g) | | | | | | |
| Lipase - Lipex ® (18 mg active/g) | 0.03 | 0.07 | 0.3 | 0.1 | 0.07 | 0.4 |
| *Amylase as described herein | 0.63 | 1.0 | 2.0 | 0.44 | 0.88 | 0.3 |
| **DNase | 0.03 | 2.0 | 0.3 | 0.1 | 0.07 | 0.4 |
| Mannanase (20 mg active/g) | 0.03 | 0.07 | 0.3 | 0.1 | 0.07 | 0.4 |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| DTPA | 0.6 | 0.8 | 0.6 | 0.25 | 0.6 | 0.6 |
| MgSO₄ | 1 | 1 | 1 | 0.5 | 1 | 1 |
| Sodium Percarbonate | 0.0 | 5.2 | 0.1 | 0.0 | 0.0 | 0.0 |
| Sodium Perborate | 4.4 | 0.0 | 3.85 | 2.09 | 0.78 | 3.63 |
| Monohydrate | | | | | | |
| NOBS | 1.9 | 0.0 | 1.66 | 0.0 | 0.33 | 0.75 |
| TAED | 0.58 | 1.2 | 0.51 | 0.0 | 0.015 | 0.28 |
| Sulphonated zinc | 0.0030 | 0.0 | 0.0012 | 0.0030 | 0.0021 | 0.0 |
| phthalocyanine | | | | | | |
| S-ACMC | 0.1 | 0.0 | 0.0 | 0.0 | 0.06 | 0.0 |
| Direct Violet 9 | 0.0 | 0.0 | 0.0003 | 0.0005 | 0.0003 | 0.0 |
| Acid Blue 29 | 0.0 | 0.0 | 0.0 | 0.0 | 0.0 | 0.0003 |

| | |
|---|---|
| Sulfate/Moisture | Balance |

*Amylase quantities each shown as mgs of active enzyme per 100 g of detergent.
**DNase (one of the examples from claim 11; mgs active enzyme per 100 g detergent.)

### Examples 7-12

Granular laundry detergent compositions designed for front-loading automatic washing machines.

| | 7 | 8 | 9 | 10 | 11 | 12 |
|---|---|---|---|---|---|---|
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE3S | 0 | 4.8 | 0 | 5.2 | 4 | 4 |
| C12-14 Alkylsulfate | 1 | 0 | 1 | 0 | 0 | 0 |
| AE7 | 2.2 | 0 | 3.2 | 0 | 0 | 0 |
| C₁₀₋₁₂ Dimethyl | 0.75 | 0.94 | 0.98 | 0.98 | 0 | 0 |
| hydroxyethylammonium chloride | | | | | | |
| Crystalline layered silicate (δ- | 4.1 | 0 | 4.8 | 0 | 0 | 0 |
| Na₂Si₂O₅) | | | | | | |
| Zeolite A | 5 | 0 | 5 | 0 | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at ratio | 0.08 | 0 | 0.11 | 0 | 0 | 0 |
| 2:1) | | | | | | |
| Soil release agent | 0.75 | 0.72 | 0.71 | 0.72 | 0 | 0 |
| Acrylic Acid/Maleic Acid | 1.1 | 3.7 | 1.0 | 3.7 | 2.6 | 3.8 |
| Copolymer | | | | | | |
| Carboxymethylcellulose | 0.15 | 1.4 | 0.2 | 1.4 | 1 | 0.5 |
| Protease as described herein, e.g | 0.2 | 0.2 | 0.3 | 0.15 | 0.12 | 0.13 |
| Purafect ® (84 mg active/g) | | | | | | |
| Lipase - Lipex ® (18.00 mg | 0.05 | 0.15 | 0.1 | 0 | 0 | 0 |
| active/g) | | | | | | |
| Cellulase - Celluclean ™ (15.6 mg | 0 | 0 | 0 | 0 | 0.1 | 0.1 |
| active/g) | | | | | | |
| **DNase | 4.0 | 2.0 | 1.0 | 0.7 | 6.0 | 3.0 |
| *Amylase as described herein | 0.15 | 0.04 | 0.03 | — | 0.01 | 0.16 |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer | | | | | | |
| (EDDS) | | | | | | |
| Hydroxyethane di phosphonate | 0.2 | 0.2 | 0.2 | 0.2 | 0.2 | 0.2 |
| (HEDP) | | | | | | |
| MgSO₄ | 0.42 | 0.42 | 0.42 | 0.42 | 0.4 | 0.4 |
| Perfume | 0.5 | 0.6 | 0.5 | 0.6 | 0.6 | 0.6 |
| Suds suppressor agglomerate | 0.05 | 0.1 | 0.05 | 0.1 | 0.06 | 0.05 |
| Soap | 0.45 | 0.45 | 0.45 | 0.45 | 0 | 0 |
| Sulphonated zinc phthalocyanine | 0.0007 | 0.0012 | 0.0007 | 0 | 0 | 0 |
| (active) | | | | | | |
| S-ACMC | 0.01 | 0.01 | 0 | 0.01 | 0 | 0 |
| Direct Violet 9 (active) | 0 | 0 | 0.0001 | 0.0001 | 0 | 0 |

| | |
|---|---|
| Sulfate/Water & Miscellaneous | Balance |

*Amylase quantities each shown as mgs of active enzyme per 100 g of detergent.
**DNase (one of the examples from claim 11; mgs active enzyme per 100 g detergent.)

### Examples 13-18

### Heavy Duty Liquid Laundry Detergent Compositions

| | 13 | 14 | 15 | 16 | 17 | 18 |
|---|---|---|---|---|---|---|
| | (wt %) | (wt %) | (wt %) | (wt %) | (wt %) | (wt %) |
| C₁₂₋₁₅ Alkylethoxy(1.8)sulfate | 14.7 | 11.6 | | 16.31 | | 17.29 |
| C_{11.8} Alkylbenzene sulfonate | 4.3 | 11.6 | 8.3 | 7.73 | 11.7 | 7.73 |
| C₁₆₋₁₇ Branched alkyl sulfate | 1.7 | 1.29 | | 3.09 | | 3.3 |
| C₁₂₋₁₄ Alkyl -9-ethoxylate | 0.9 | 1.07 | | 1.31 | | 1.31 |
| C₁₂ dimethylamine oxide | 0.6 | 0.64 | | 1.03 | | 1.03 |
| Citric acid | 3.5 | 0.65 | 3 | 0.66 | 2.27 | 0.67 |
| C₁₂₋₁₈ fatty acid | 1.5 | 2.32 | 3.6 | 1.52 | 0.82 | 1.52 |
| Sodium Borate (Borax) | 2.5 | 2.46 | 1.2 | 2.53 | | 2.53 |
| Sodium C₁₂₋₁₄ alkyl ethoxy 3 | | | 2.9 | | 3.9 | |
| sulfate | | | | | | |
| C₁₄₋₁₅ alkyl 7-ethoxylate | | | 4.2 | | 1.9 | |
| C₁₂₋₁₄ Alkyl -7-ethoxylate | | | 1.7 | | 0.5 | |
| Ca chloride dihydrate | | | | | | 0.045 |
| Ca formate | 0.09 | 0.09 | | 0.09 | | 0.09 |
| A compound: | | | 1.2 | | 0.66 | |
| bis- | | | | | | |
| ((C₂H₅O)(C₂H₄O)n)(CH₃)—N⁺—CₓH₂ₓ—N⁺—(CH₃)—bis- | | | | | | |
| ((C₂H₅O)(C₂H₄O)n); n is 20 to | | | | | | |
| 30; x is 3 to 8, optionally sulphated | | | | | | |
| or sulphonated | | | | | | |
| Random graft co-polymer¹ | | 1.46 | 0.5 | | 0.83 | |
| Ethoxylated Polyethylenimine² | 1.5 | 1.29 | | 1.44 | | 1.44 |
| Diethylene triamine pentaacetic acid | 0.34 | 0.64 | | 0.34 | | 0.34 |
| Diethylene triamine penta | | | 0.3 | | 0.3 | |
| (methylene phosphonic acid) | | | | | | |
| 1-hydroxyethyidene-1,1- | | | | | 0.18 | |
| diphosphonic acid | | | | | | |
| Dihydroxybenzene-3,5-disulfonic | | | | | | 0.19 |
| acid disodium salt hydrate | | | | | | |
| Tinopal AMS-GX | | 0.06 | | | | 0.29 |
| Tinopal CBS-X | 0.2 | 0.17 | | 0.29 | | |
| Tinopal TAS-X B36 | | | | | 0.091 | |
| Amphiphilic alkoxylated grease | 1.28 | 1 | 0.4 | 1.93 | | 1.93 |
| cleaning polymer³ | | | | | | |
| CHEC | | | 0.2 | | | |
| Ethanol | 2 | 1.58 | 1.6 | 5.4 | 1.2 | 3.57 |
| Propylene Glycol | 3.9 | 3.59 | 1.3 | 4.3 | | 3.8 |
| Diethylene glycol | 1.05 | 1.54 | | 1.15 | | 1.15 |
| Polyethylene glycol | 0.06 | 0.04 | | 0.1 | | 0.1 |
| *DNase | 0.1 | 0.15 | 0.15 | 0.12 | 0.4 | 0.05 |
| *Amylase | 0.50 | 0.10 | 0.2 | 0.4 | 1.0 | 0.7 |
| Cellulase - Celluclean ™ (15.6 mg | 0 | 0.3 | 0 | 0 | 0.1 | 0.1 |
| active/g) | | | | | | |
| Protease as described herein, e.g | 0.2 | 0.2 | 0.3 | 0.15 | 0.12 | 0.13 |
| Purafect ® (84 mg active/g) | | | | | | |
| Mannanase | 0.01 | 0.1 | 0.15 | 0.12 | — | 0.05 |
| Lipase - Lipex ® (18.00 mg active/g) | 0.05 | 0.15 | — | — | — | — |
| Monoethanolamine | 3.05 | 2.41 | 0.4 | 1.26 | 0.31 | 1.13 |
| NaOH | 2.44 | 1.8 | | 3.01 | 3.84 | 0.24 |
| Sodium Cumene Sulphonate | | | 1 | | 0.95 | |
| Sodium Formate | | 0.11 | | 0.09 | 0.2 | 0.12 |

| | |
|---|---|
| Water, Aesthetics (Dyes, perfumes) | balance |
| and Minors | |

¹Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.
²Polyethylenimine (MW = 600) with 20 ethoxylate groups per —NH.
³Amphiphilic alkoxylated grease cleaning polymer is a polyethylenimine (MW = 600) with 24 ethoxylate groups per —NH and 16 propoxylate groups per —NH
*Amylase and DNase (one of the DNases from claim 11) quantities shown as mgs of active enzyme per 100 g of detergent.

### Examples 19-21

### Heavy Duty Liquid Laundry Detergent Composition

| | 19 | 20 | 21 |
|---|---|---|---|
| | (wt %) | (wt %) | (wt %) |
| Sodium Alkylbenzene sulfonate | 21.0 | 10.2 | 3.53 |
| C₁₂₄₋₁₈ Alkyl 1.5-9-ethoxylate | 18.0 | 6.32 | 0.88 |
| Branched Alkyl Sulfate | | | 2.44 |
| Sodium Alkyl ethoxy 1-3 sulfate | | 1.17 | 14.81 |
| Citric Acid | | 3.14 | 2.05 |
| C₁₂ Dimethylamine oxide | | | 0.56 |
| C₁₂₋₁₈ Fatty acid | 15.0 | 2.59 | 1.48 |
| Protease (Purafect Prime ®, 40.6 mg active/g) | 1.5 | 0.52 | 1.64 |
| Mannanase (Mannaway ®, 11 mg active/g) | 0.1 | 0.06 | |
| Xyloglucanase (Whitezyme ®, 20 mg active/g) | 0.2 | 0.06 | |
| Lipase (Lipex) | 0.1 | 0.2 | 0.05 |
| DNase (40.6 mg active/g) | 1.5 | 0.5 | 1.4 |
| *Amylase (mg active) | 5.9 | 2.3 | 12.8 |
| bis((C₂H₅O)(C₂H₄O)n)(CH₃)—N⁺—CₓH₂ₓ—N⁺—(CH₃)— | 2.0 | 0.63 | |
| bis((C₂H₅O)(C₂H₄O)n), wherein n = from 20 to 30, | | | |
| and x = from 3 to 8, optionally sulphated or | | | |
| sulphonated | | | |
| Random graft co-polymer¹ | | 1.07 | |
| Ethoxylated Polyethylenimine ² | 0.8 | | 1.51 |
| Amphiphilic alkoxylated polymer³ | | | |
| Cellulase | 0.3 | 0.3 | 0.4 |
| Phosphonated chelant | 0.8 | 0.41 | 0.53 |
| Hydrotrope | | 0.93 | |
| Brightener | 0.2 | 0.09 | 0.19 |
| Ethoxylated thiophene Hueing Dye | 0.004 | | |
| Minors: dyes, perfume, perfume micro capsules, | Balance | Balance | Balance |
| enzymes, enzyme stabilizers, solvents, | | | |
| structurants, pH modifying agents | | | |

*Amylase is shown as mgs of active enzyme per 100 g of detergent.
**Based on total cleaning and/or treatment composition weight, a total of no more than 7% water.

### Raw Materials and Notes for Cleaning Composition Examples 1-21

Linear alkylbenzenesulfonate having an average aliphatic carbon chain length C₁₁-C₁₈

C₁₂₋₁₈ Dimethylhydroxyethyl ammonium chloride

AE3S is C₁₂₋₁₅ alkyl ethoxy (3) sulfate

AE7 is C₁₂₋₁₅ alcohol ethoxylate, with an average degree of ethoxylation of 7

AE9 is C₁₂₋₁₆ alcohol ethoxylate, with an average degree of ethoxylation of 9

HSAS is a mid-branched primary alkyl sulfate with carbon chain length of about 16-17 as disclosed in U.S. Pat. Nos. 6,020,303 and 6,060,443

Polyacrylate MW 4500 is supplied by BASF

Carboxymethyl cellulose is Finnfix® V supplied by CP Kelco, Arnhem, Netherlands CHEC is a cationically modified hydroxyethyl cellulose polymer.

Phosphonate chelants are, for example, diethylenetetraamine pentaacetic acid (DTPA)

Hydroxyethane di phosphonate (HEDP)

Savinase®, Natalase®, Stainzyme®, Lipex®, Celluclean™, Mannaway® and Whitezyme® are all products of Novozymes, Bagsvaerd, Denmark.

Purafect®, Purafect Prime® are products of Genencor International, Palo Alto, Calif., USA

Fluorescent Brightener 1 is Tinopal® AMS, Fluorescent Brightener 2 is Tinopal® CBS-X, Direct Violet 9 is Pergasol® Violet BN-Z NOBS is sodium nonanoyloxybenzenesulfonate TAED is tetraacetylethylenediamine

S-ACMC is carboxymethylcellulose conjugated with C.I. Reactive Blue 19product name AZO-CM-CELLULOSE

Soil release agent is Repel-o-tex® PF

Acrylic Acid/Maleic Acid Copolymer is molecular weight 70,000 and acrylate:maleate ratio 70:30 EDDS is a sodium salt of ethylenediamine-N,N′-disuccinic acid, (S,S) isomer Suds suppressor agglomerate is supplied by Dow Corning, Midland, Mich., USA

HSAS is mid-branched alkyl sulfate

Liquitint® Violet CT is supplied by Milliken, Spartanburg, S.C., USA

¹ Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.

² Polyethyleneimine (MW=600) with 20 ethoxylate groups per —NH.

³Amphiphilic alkoxylated polymer is a polyethylenimine (MW 600), prepared from a polymer that is derivatised to contain 24 ethoxylate groups per —NH and 16 Propoxylate groups per —NH.

Amylase⁴ is any of a) to k) herein (mg active protein).

### Examples 22-26

### Unit Dose Laundry Detergent Compositions. Such Unit Dose Formulations can Comprise One or Multiple Compartments

| | 22 | 23 | 24 | 25 | 26 |
|---|---|---|---|---|---|
| | (wt %) | (wt %) | (wt %) | (wt %) | (wt %) |
| Alkylbenzene sulfonic acid | 14.5 | 14.5 | 14.5 | 14.5 | 14.5 |
| C₁₂₋₁₈ alkyl ethoxy 3 sulfate | 7.5 | 7.5 | 7.5 | 7.5 | 7.5 |
| C₁₂₋₁₈ alkyl 7-ethoxylate | 13.0 | 13.0 | 13.0 | 13.0 | 13.0 |
| Citric Acid | 0.6 | 0.6 | 0.6 | 0.6 | 0.6 |
| Fatty Acid | 14.8 | 14.8 | 14.8 | 14.8 | 14.8 |
| DNase | 0.1 | 0.05 | 0.1 | 0.2 | 0.1 |
| lipase (mg active) | 0.2 | — | — | — | — |
| Ethoxylated Polyethylenimine¹ | 4.0 | 4.0 | 4.0 | 4.0 | 4.0 |
| Protease (Purafect Prime ®, 40.6 mg | 1.4 | 2.0 | 0.9 | 1.2 | 0 |
| active/g) | | | | | |
| Cellulase (Celluclean, active protein) | 0.1 | 0.2 | — | — | 0.1 |
| Amylase (active protein) herein | 0.1 | 0.05 | 0.1 | 0.2 | 0.1 |
| Hydroxy ethane diphosphonic acid | 1.2 | 1.2 | 1.2 | 1.2 | 1.2 |
| Brightener | 0.3 | 0.3 | 0.3 | 0.3 | 0.3 |
| P-diol | 15.8 | 13.8 | 13.8 | 13.8 | 13.8 |
| Glycerol | 6.1 | 6.1 | 6.1 | 6.1 | 6.1 |
| MEA | 8.0 | 8.0 | 8.0 | 8.0 | 8.0 |
| TIPA | — | — | 2.0 | — | — |
| TEA | — | 2.0 | — | — | — |
| Cumene sulphonate | — | — | — | — | 2.0 |
| cyclohexyl dimethanol | — | — | — | 2.0 | — |
| Water | 10 | 10 | 10 | 10 | 10 |
| Structurant | 0.14 | 0.14 | 0.14 | 0.14 | 0.14 |
| Perfume | 1.9 | 1.9 | 1.9 | 1.9 | 1.9 |

| | |
|---|---|
| Buffers (monoethanolamine) | To pH 8.0 |
| Solvents (1,2 propanediol, ethanol) | To 100% |

*Amylase of the present invention is shown as mgs of active enzyme per 100 g of detergent.
¹Polyethylenimine (MW = 600) with 20 ethoxylate groups per-NH.

### Example 27

### Multiple Compartment Unit Dose Composition

Multiple compartment unit dose laundry detergent formulations of the present invention are provided below. In these examples the unit dose has three compartments, but similar compositions can be made with two, four or five compartments. The film used to encapsulate the compartments is polyvinyl alcohol.

| | 27 |
|---|---|
| Base composition 1 | (wt %) |
| Glycerol (min 99) | 5.3 |
| 1,2-propanediol | 10.0 |
| Citric Acid | 0.5 |
| Monoethanolamine | 10.0 |
| Caustic soda | — |
| Dequest 2010 | 1.1 |
| Potassium sulfite | 0.2 |
| *DNase (mg active) | 8.0 |
| Nonionic Marlipal C24EO7 | 20.1 |
| HLAS | 24.6 |
| Optical brightener FWA49 | 0.2 |
| C12-15 Fatty acid | 16.4 |
| Polymer Lutensit Z96 | 2.9 |
| Polyethyleneimine ethoxylate PEI600 E20 | 1.1 |
| MgCl2 | 0.2 |
| Solvents (1,2 propanediol, ethanol) | To 100% |

### Multi-Compartment Formulations

| | Composition | | | | | |
|---|---|---|---|---|---|---|
| | 1 | | | 2 | | |
| | Compartment | | | | | |
| | A | B | C | A | B | C |
| Volume of each | 40 ml | 5 ml | 5 ml | 40 ml | 5 ml | 5 ml |
| compartment | | | | | | |
| Active material in Wt.% | | | | | | |
| Perfume | 1.6 | 1.6 | 1.6 | 1.6 | 1.6 | 1.6 |
| Dyes | <0.01 | <0.01 | <0.01 | <0.01 | <0.01 | <0.01 |
| TiO2 | 0.1 | — | — | — | 0.1 | — |
| Sodium Sulfite | 0.4 | 0.4 | 0.4 | 0.3 | 0.3 | 0.3 |
| Acusol 305 | 1.2 | | | 2 | — | — |
| Hydrogenated castor oil | 0.14 | 0.14 | 0.14 | 0.14 | 0.14 | 0.14 |
| Base Composition 1 | Add to | Add to | Add to | Add to | Add to | Add to |
| | 100% | 100% | 100% | 100% | 100% | 100% |

*DNase of the present invention is shown as mgs of active enzyme per 100 g of detergent in all examples unless stated to the contrary for a specific example.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

What is claimed is:

1. A cleaning composition comprising: (i) a DNase having at least 60% sequence identity to the DNase shown in SEQ ID NO: 1; (ii) at least one additional enzyme selected from the group consisting of mannanases, amylases, cellulases, lipases, proteases, and mixtures thereof and (iii) a cleaning adjunct.

2. A cleaning composition according to claim 1 wherein the cleaning adjunct comprises a surfactant.

3. A composition according to claim 1, wherein the additional enzyme comprises a mannanase, and wherein the mannanase is selected from the group consisting of:
a) a mannanase belonging to the Glycoside Hydrolase Family 5 mannanases, optionally additionally having at least 60% sequence identity to SEQ ID NO: 15;
b) a mannanase having at least 60% sequence identity to SEQ ID NO: 15; or
c) a mannanase belonging to the Glycoside Hydrolase Family 26 mannanases;
i. a mannanase having at least 60% sequence identity to SEQ ID NO: 16;
ii. a mannanase having at least 60% sequence identity to SEQ ID NO: 17;
iii. a mannanase having at least 60% sequence identity to SEQ ID NO: 18;
iv. a mannanase having at least 60% sequence identity to SEQ ID NO: 19;
v. a mannanase having at least 60% sequence identity to SEQ ID NO: 20;
vi. a mannanase having at least 60% sequence identity to SEQ ID NO: 21;
vii. a mannanase having at least 60% sequence identity to SEQ ID NO: 22;
viii. a mannanase having at least 60% sequence identity to SEQ ID NO: 23;
ix. a mannanase having at least 60% sequence identity to SEQ ID NO: 24;
x. a mannanase having at least 60% sequence identity to SEQ ID NO: 33; and
xi. a mannanase having at least 60% sequence identity to SEQ ID NO: 34; and mixtures thereof.

4. A cleaning composition according to claim 1, wherein the amount of DNase in the composition is from 0.01 to 1000 ppm and the amount of the or each additional enzyme is from 0.01 to 1000 ppm.

5. A cleaning composition according to claim 1, wherein the mannanase, amylase, cellulase, lipase or protease or mixtures thereof provides at least one enzyme detergency benefit.

6. A cleaning composition according to claim 1 wherein the additional enzyme comprises amylase and the amylase is selected from the group consisting of:
a) an amylase having at least 60% sequence identity to SEQ ID NO: 2 or SEQ ID NO: 35, or an amylase having at least 60% sequence identity but less than 100% sequence identity to SEQ ID NO: 2 or SEQ ID NO: 35 comprising a two amino acid deletion in the sequence region R180, S181, T182, G183, compared to SEQ ID NO: 2, wherein each position corresponds to the position in SEQ ID NO: 2;
b) an amylase having at least 60% but less than 100% sequence identity to SEQ ID NO: 2 or SEQ ID NO: 35 comprising one of the alterations set selected from the group consisting of:
a. R180*, S181*, S243Q, G475K;
b. R180*, T182*, S243Q, G475K;
c. R180*, T182*, G183S, S243Q, G475K; and
d. R180*, S181*, Y242F, S243Q, F266Y, G475K compared to SEQ ID NO: 2, wherein each position corresponds to the position in SEQ ID NO: 2;
c) an amylase having at least 60% sequence identity to SEQ ID NO: 3, or an amylase having at least 60% but less than 100% sequence identity to SEQ ID NO: 3, comprising a two amino acid deletion in the sequence region R178, G179, T180, G181 compared to SEQ ID NO: 3, wherein each position corresponds to the position in SEQ ID NO: 3;
d) an amylase having at least 60% sequence identity to SEQ ID NO: 3, or an amylase having at least 60% but less than 100% sequence identity to SEQ ID NO: 3, comprising one of the alteration sets selected from the group consisting of:
I. R178*, G179*, E187P, I203Y, G476K;
II. R178*, G179*, E187P, M199L, I203Y, G476K;
III. R178*, G179*, E187P, I203Y R458N, T459S, D460T, G476K;
IV. N126Y, F153W, R178*, G179*, T180H, I203Y, S241Q;
V. N126Y, F153W, R178*, G179*, T180H, I203Y, S241Q, S362A, R377Y;
VI. T38N, N126Y, T129I, F153W, R178*, G179*, T180D, E187P, I203Y, G476K, G477E; and
VII. N126Y, F153W, R178*, G179*, T180H, E187P, I203Y, S241Q, G476K, G477E, compared to SEQ ID NO: 3, wherein each position corresponds to the position in SEQ ID NO: 3;
e) an amylase having at least 60% sequence identity to SEQ ID NO: 4, or an amylase having at least 60% but less than 100% sequence identity to SEQ ID NO: 4, comprising a two amino acid deletion in the sequence region R181, G182, D183, G184 compared to SEQ ID NO: 4, wherein each position corresponds to the position in SEQ ID NO: 4;
f) an amylase having at least 60% sequence identity to SEQ ID NO: 4, or an amylase having at least 60% but less than 100% sequence identity to SEQ ID NO: 4 comprising an alteration at one or more of the position(s) selected from 3, 4, 5, 74, 118, 167, 170, 177, 195, 202, 204, 271, 320, 330, 377, 385, 445, 458, 475, 476, 314, 315 or 316, compared to SEQ ID NO: 4, wherein each position corresponds to the position in SEQ ID NO: 4;
g) an amylase having at least 60% sequence identity to SEQ ID NO: 5, or an amylase having at least 60% but less than 100% sequence identity to SEQ ID NO: 5 comprising a two amino acid deletion in the sequence region R181, G182, D183, G184, compared to SEQ ID NO: 5, wherein each position corresponds to the position in SEQ ID NO: 5;
h) an amylase having at least 60% sequence identity to SEQ ID NO: 5, or an amylase having at least 60% but less than 100% sequence identity to SEQ ID NO: 5 comprising one of the alteration sets selected from the group consisting of
a. D183*, G184*, N195F, Y243F;
b. D183*, G184*, N195F, V206Y, Y243F;
c. W140Y, D183*, G184*, N195F, V206Y, Y243F, E260G, G304R, G476K;
d. W140Y, D183*, G184*, N195F, V206Y, Y243F, E260G, G477E;
e. W140Y, D183*, G184*, N195F, V206Y, Y243F, W284D;
f. W140Y, N195F, V206Y, Y243F, E260G, G477E;
g. G109A, W140Y, N195F, V206Y, Y243F, E260G;
h. T51I, S52Q, N54K, G109A, W140Y, N195F, V206Y, Y243F, E260G, G476E;
i. W140Y, N195F, V206Y, Y243F, E260G, W284R, G477K;
j. W140Y, N195F, V206Y, Y243F, E260G, W284F, G477R; and
k. H_{1*,} G7A, G109A, W140Y, D183*, G184*, N195F, V206Y, Y243F, E260G, N280S, G304R, E391A, G476K, compared to SEQ ID NO: 5, wherein each position corresponds to the position in SEQ ID NO: 5;
i) an amylase having at least 60% sequence identity to SEQ ID NO: 6, or an amylase having at least 60% but less than 100% sequence identity to SEQ ID NO: 6, comprising a two amino acid deletion in the sequence region R181, G182, D183, G184, compared to SEQ ID NO: 6, wherein each position corresponds to the position in SEQ ID NO: 6;
j) an amylase having at least 60% sequence identity to SEQ ID NO: 6, or an amylase having at least 60% but less than 100% sequence identity to SEQ ID NO: 6, comprising one of the alteration sets selected from the group consisting of
I. R118K, D183*, G184*, N195F, R320K, R458K;
II. M9l, D183*, G184*, R118K, N195F, M202L, R320K, M323T, R458K;
III. M9L, G149A, R118K, G182T, D183*, G184*, G186A, N195F, M202L, T257I, Y295F, N299Y, M323T, A339S, E345R, R458K;
IV. M9L, G149A, R118K, G182T, D183*, G184*, G186A, N195F, T246V, T257I, Y295F, N299Y, M323T, A339S, E345R, R458K; and
V. M9L, G149A, G182T, D183*, G184*, G186A, M202L, T257I, Y295F, N299Y, M323T, A339S, E345R, N471E, compared to SEQ ID NO: 6, wherein each position corresponds to the position in SEQ ID NO: 6;
k) an amylase having at least 60% sequence identity to SEQ ID NO: 7, or an amylase having at least 60% but less than 100% sequence identity to SEQ ID NO: 7, comprising a two amino acid deletion in the sequence region R181, G182, D183, G184, compared to SEQ ID NO: 7, wherein each position corresponds to the position in SEQ ID NO: 7;
l) an amylase having at least 60% sequence identity to SEQ ID NO: 7, or an amylase having at least 60% but less than 100% sequence identity to SEQ ID NO: 7, comprising one of the alteration sets selected from the group consisting of
a. D183*, G184*, N195F, V206Y, R320K, R458K;
b. D183*, G184*, N195F, M202L, V206L, R320K, R458K;
c. G149A, G182T, D183*, G184*, N195F, M202L, V206L, T257I, Y295F, Q299Y, A339S, Q345R, R458K;
d. G149A, G182T, D183*, G184*, N195F, V206L, M246V, T257I, Y295F, Q299Y, A339S, Q345R, R458K;
e. G149A, G182T, D183*, G184*, M202L, V206L, T257I, Y295F, Q299Y, A339S, Q345R, H₄₇₁E; and
f. H₁A, N54S, V56T, K72R, G109A, F113Q, R116Q, W167F, Q172G, A174S, G182*, D183*, G184T, N195F, V206L, K391A, F473R, G476K, compared to SEQ ID NO: 7, wherein each position corresponds to the position in SEQ ID NO: 7;
m) an amylase having at least 60% sequence identity to SEQ ID NO: 8, or an amylase having at least 60% but less than 100% sequence identity to SEQ ID NO: 8, comprising a two amino acid deletion in the sequence region R181, G182, H_{183,} G184, compared to SEQ ID NO: 8, wherein each position corresponds to the position in SEQ ID NO: 8;
n) an amylase having at least 60% sequence identity to SEQ ID NO: 8, or an amylase having at least 60% but less than 100% sequence identity to SEQ ID NO: 8, comprising one of the alteration sets selected from the group consisting of
a. H_{183*,} G184*, I405L, A421H, A422P, A428T;
b. R118K, H_{183*,} G184*, N195F, R320K, R458K;
c. M9l, H_{183*,} G184*, R118K, N195F, M202L, R320K, S323T, R458K;
d. M9L, G149A, R118K, G182T, H_{183*,} G184*, N195F, M202L, T257I, Y295F, N299Y, A339S, E345R, R458K;
e. M9L, G149A, R118K, G182T, H_{183*,} G184*, N195F, T246V, T257I, Y295F, N299Y, A339S, E345R, R458K; and
f. M9L, G149A, G182T, H_{183*,} G184*, M202L, T257I, Y295F, N299Y, S323T, A339S, E345R, compared to SEQ ID NO: 8, wherein each position corresponds to the position in SEQ ID NO: 8;
o) an amylase having at least 60% sequence identity to SEQ ID NO: 9, or an amylase having at least 60% but less than 100% sequence identity to SEQ ID NO: 9, comprising a two amino acid deletion in the sequence region R181, G182, G182, D183, compared to SEQ ID NO: 9, wherein each position corresponds to the position in SEQ ID NO: 9; and
p) an amylase having at least 60% sequence identity to SEQ ID NO: 9, or an amylase having at least 60% but less than 100% sequence identity to SEQ ID NO: 9, comprising one of the alteration sets selected from the group consisting of
a. H_{1*,} D183*, G184*, N195F, V206Y;
b. H_{1*,} D183*, G184*, N195F, M202L, V206L, R320K, R458K;
c. G149A, G182T, D183*, G184*, N195F, M202L, V206L, T257I, Y295F, Q299Y, A339S, Q345R, R458K;
d. G149A, G182T, D183*, G184*, N195F, V206L, M246V, T257I, Y295F, Q299Y, A339S, Q345R, R458K;
e. G149A, G182T, D183*, G184*, M202L, V206L, T257I, Y295F, Q299Y, A339S, Q345R,
f. H_{1*,} N54S, V56T, G109A, Q169E, Q172K, A174*, G182*, D183*, N195F, V206L, K391A, G476K;
g. G182*, D183*, N195F, W140Y, N260G, S304R, R320A, G476K, V4101, V429l, F451W, C₄₇₄V;
h. H_{1*,} N54S, V56T, K72R, G109A, F113Q, R116Q, W167F, Q172G, A174S, G182*, D183*, G184T, N195F, V206L, K391A, P473R, G476K;
i. H_{1*,} N54S, V56T, G109A, Q169E, Q172K, A174*, G182*, D183*, N195F, V206L, K391A, G476K;
j. H_{1*,} N54S, V56T, G109A, R116H, A174S, G182*, D183*, N195F, V206L, K391A, G476K;
k. H_{1*,} N54S, V56T, K72R, G109A, F113Q, R116Q, W167F, Q172G, A174S, G182*, D183*, G184T, N195F, V206L, K391A, P473R, G476K;
l. H_{1*,} N54S, V56T, G109A, F113Q, R116Q, Q172N, A174S, G182*, D183*, N195F, V206L, A265G, K391A, P473R, G476K;
m. H_{1*,} N54S, V56T, K72R, G109A, F113Q, W167F, Q172R, A174S, G182*, D183*, N195F, V206L, K391A, G476K;
n. H_{1*,} N54S, V56T, K72R, G109A, R116H, T134E, W167F, Q172G, L173V, A174S, G182*, D183*, N195F, V206L, G255A, K391A, G476K;
o. H_{1*,} N54S, V56T, K72R, G109A, R116H, T134E, W167F, Q172G, L173V, A174S, G182*, D183*, N195F, V206L, G255A, K391A, Q395P, T444Q, P473R, G476K;
p. H_{1*,} N54S, V56T, G109A, T134E, A174S, G182*, D183*, N195F, V206L, K391A, G476K;
q. H_{1*,} N54S, V56T, K72R, G109A, A174S, G182*, D183*, N195F, V206L, G255A, K391A, G476K;
r. H_{1*,} N54S, V56T, G109A, W167F, Q172E, L173P, A174K, G182*, D183*, N195F, V206L, K391A, G476K;
s. H_{1*,} N54S, V56T, G109A, R116Q, V120L, Q172G, L173V, A174S, G182*, D183*, G184T, N195F, V206L, A422P;
t. H_{1*,} N54S, V56T, G109A, F113Q, R116Q, W167F, Q172G, 1173V, A174S, G182*, D183*, G184T, N195F, V206L, A422P compared to SEQ ID NO: 9, wherein each position corresponds to the position in SEQ ID NO: 9; and
q) mixtures thereof.

7. A composition according to claim 1, wherein the additional enzyme comprises a cellulase, and wherein the cellulase is selected from the group consisting of:
a) a cellulase having at least 60% sequence identity to SEQ ID NO: 10;
b) a cellulase having at least 60% sequence identity to SEQ ID NO: 11;
c) a cellulase having at least 60% sequence identity to SEQ ID NO: 12
d) a cellulase having at least 60% sequence identity to SEQ ID NO: 13,
e) a cellulase having at least 60% sequence identity to SEQ ID NO: 31, and
f) a cellulase having at least 60% sequence identity to SEQ ID NO: 32; and
g) mixtures thereof.

8. A composition according to claim 1, wherein the additional enzyme comprises a lipase, and wherein the lipase is a lipase having at least 60% sequence identity to SEQ ID NO: 14, or a lipase having at least 60% but less than 100% sequence identity to SEQ ID NO: 14 comprising one or more of the substitutions selected from the group consisting of D27R, G38A, G91A/Q, D96E, G163K, T231R, N233R, D254S and P256T, compared to SEQ ID NO: 14, wherein each position corresponds to the position in SEQ ID NO: 14; and mixtures thereof.

9. A composition according to claim 1, wherein the additional enzyme comprises a protease, and wherein the protease is selected from the group consisting of:
a) a protease having at least 60% sequence identity to SEQ ID NO: 25;
b) a protease having at least 60% sequence identity to SEQ ID NO: 26;
c) a protease having at least 60% sequence identity to SEQ ID NO: 27;
d) a protease having at least 60% sequence identity to SEQ ID NO: 28;
e) a protease having at least 60% sequence identity to SEQ ID NO: 29;
f) a protease having at least 60% sequence identity to SEQ ID NO: 30; or
g) a protease having at least 60% but less than 100% sequence identity to SEQ ID NO:
25, wherein the protease comprises the substitution T22R or T22A compared to SEQ ID NO: 25, wherein the position corresponds to the position of SEQ ID NO: 25;
h) a protease having at least 60% but less than 100% sequence identity to SEQ ID NO: 25, wherein the protease comprises one or more or all of the substitutions selected from the group consisting of: S3T, V4I, A188P and V199I, compared to SEQ ID NO: 25, wherein the positions correspond to the positions of SEQ ID NO: 25;
i) a protease having at least 60% but less than 100% sequence identity to SEQ ID NO: 25, wherein the protease comprises one or more or all of the substitutions selected from the group consisting of N114L, T207A, A226V, and E265F, compared to SEQ ID NO: 25, wherein the positions correspond to the positions of SEQ ID NO: 25;
j) a protease having at least 60% but less than 100% sequence identity to SEQ ID NO: 25, wherein the protease comprises one or more or all of the substitutions selected from the group consisting of: S97D, S101A, V102I and G157S compared to SEQ ID NO: 25, wherein the positions correspond to the positions of SEQ ID NO: 25;
k) a protease having at least 60% but less than 100% sequence identity to SEQ ID NO: 25, wherein the protease comprises one or more or all of the substitutions selected from the group consisting of: S85N, G116V, S126L, P127Q and S128A compared to SEQ ID NO: 25, wherein the positions correspond to the positions of SEQ ID NO: 25;
l) a protease having at least 60% but less than 100% sequence identity to SEQ ID NO: 25, wherein the protease comprises one or more or all of the substitutions selected from the group consisting of: Y161A, R164S and A188P, compared to SEQ ID NO: 25, wherein the positions correspond to the positions of SEQ ID NO: 25;
m) a protease having at least 60% but less than 100% sequence identity to SEQ ID NO: 25, wherein the protease comprises one or more or all of the substitutions selected from the group consisting of: S3T, R19L, and A188P, wherein the positions correspond to the positions of SEQ ID NO: 25;
n) a protease having at least 60% but less than 100% sequence identity to SEQ ID NO: 25, wherein the protease comprises one or more or all of the substitutions selected from the group consisting of: S9R, R19L, and N60D, wherein the positions correspond to the positions of SEQ ID NO: 25;
o) a protease having at least 60% but less than 100% sequence identity to SEQ ID NO: 25, wherein the protease comprises the amino acid Arginine (R), at a position corresponding to a position selected from the group consisting of: 9, 42 and 239 of SEQ ID NO: 25;
p) a protease having at least 60% but less than 100% sequence identity to SEQ ID NO: 25, wherein the protease comprises the amino acid Glutamic acid (E) or Aspartic acid (D), at a position corresponding to a position selected from the group consisting of: 9, 42, 60, 61, 74, 157, 176, 179, 182, 212, 250, 253 and 256 of SEQ ID NO: 25;
q) a protease having at least 60% but less than 100% sequence identity to SEQ ID NO: 25, wherein the protease comprises an insertion of the amino acid Aspartic acid (D) or Glutamic acid (E) at a position corresponding to position 97 of SEQ ID NO: 25;
r) a protease having at least 60% but less than 100% sequence identity to SEQ ID NO: 25, wherein the protease comprises the amino acid selected from the group consisting of: Glutamic acid (E), Aspartic acid (D), Glycine (G), Arginine (R) and Methionine (M) at a position corresponding to position 99 of SEQ ID NO: 25;
s) a protease having at least 60% but less than 100% sequence identity to SEQ ID NO: 25, wherein the protease comprises the amino acid selected from the group consisting of: Glutamic acid (E), Aspartic acid (D) and Glutamine (Q), at a position corresponding to position 211 of SEQ ID NO: 25;
t) a protease having at least 60% but less than 100% sequence identity to SEQ ID NO: 26, wherein the protease comprises the amino acid selected from the group consisting of: Glutamic acid (E), Aspartic acid (D) and Glutamine (Q), at a position corresponding to position 217 of SEQ ID NO: 26; and
u) a protease having at least 60% but less than 100% sequence identity to SEQ ID NO: 26, wherein the protease comprises one or more of the substitutions selected from the group consisting of: S24G/R, S53G, S78N, S101N, G128A/S and Y217Q/L, compared to SEQ ID NO: 26, wherein the positions correspond to the positions of SEQ ID NO: 26; and
v) mixtures thereof.

10. A composition according to claim 1, wherein the DNase comprises Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and/or Aspartic acid at position 175, wherein the position corresponds to the position of SEQ ID NO: 1 (numbered according to SEQ ID NO: 1).

11. A composition according to claim 1, wherein the DNase comprises Isoleucine at position 1, Lysine at position 4, Proline at position 25, Tryptophan at position 57, Alanine at position 130 and/or Histidine at position 147, wherein the position corresponds to the position of SEQ ID NO: 1 (numbered according to SEQ ID NO: 1).

12. A composition according to claim 1, wherein the DNase comprises:
i) Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
ii) Isoleucine at position 1,Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175. Lysine at position 4,Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
iii) Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
iv) Tyrosine at position 13, Proline at position 22, Leucine at position 27, Lysine at position 33, Proline at position 39, Glycine at position 42, Isoleucine at position 56, Tryptophan at position 57; Valine at position 59, Valine at position 65, Leucine at position 76, Arginine at position 109, Aspartic acid at position 116, Valine at position 127, Proline at position 144, Leucine at position 167 and Aspartic acid at position 175;
v) Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
vi) Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Histidine at position 147, Leucine at position 167 and Aspartic acid at position 175;
vii) Isoleucine at position 1, Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
viii) Isoleucine at position 1, Lysine at position 4, Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
ix) Tyrosine at position 13, Proline at position 22, Leucine at position 27, Proline at position 25, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Leucine at position 167 and Aspartic acid at position 175;
x) Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xi) Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and Aspartic acid at position 175;
xii) Isoleucine at position 1, Lysine at position 4, Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Proline at position 144, Leucine at position 167 and Aspartic acid at position 175;
xiii) Lysine at position 4, Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Leucine at position 167 and Aspartic acid at position 175;
xiv) Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xv) Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and Aspartic acid at position 175;
xvi) Isoleucine at position 1, Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xvii) Isoleucine at position 1, Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xviii) Isoleucine at position 1, Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Histidine at position 147, Leucine at position 167 and Aspartic acid at position 175;
xix) Lysine at position 4, Tyrosine at position 13, Proline at position 22, Proline at position 25, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xx) Lysine at position 4, Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Leucine at position 167 and Aspartic acid at position 175;
xxi) Lysine at position 4, Tyrosine at position 13, Proline at position 22, Leucine at position 27, Lysine at position 33, Proline at position 39, Glycine at position 42, Isoleucine at position 56, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and Aspartic acid at position 175;
xxii) Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Leucine at position 167 and Aspartic acid at position 175;
xxiii) Tyrosine at position 13, Proline at position 22, Proline at position 25, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Proline at position 144, Histidine at position 147, Leucine at position 167 and Aspartic acid at position 175; or
xxiv) Tyrosine at position 13, Proline at position 22, Leucine at position 27, Lysine at position 33, Proline at position 39, Glycine at position 42, Isoleucine at position 56, Tryptophan at position 57, Valine at position 59, Valine at position 65, Leucine at position 76, Arginine at position 109, Aspartic acid at position 116, Valine at position 127, Alanine at position 130, Proline at position 144, Histidine at position 147, Leucine at position 167 and Aspartic acid at position 175;wherein the position corresponds to the position of SEQ ID NO: 1 (numbered according to SEQ ID NO: 1); or
xxv) mixtures thereof.

13. A cleaning composition according to claim 1 comprising an anionic surfactant and a nonionic surfactant in a weight ratio from 50:1 to 1:2.

14. A cleaning composition according to claim 1 wherein the cleaning adjunct comprises further additional enzyme elected from the group consisting of: pectinases, pectin lyases, xanthanases, xanthan lyases, hexosaminidases, laccases and catalases, or any mixture thereof.

15. A cleaning composition according to claim 1 in the form of a liquid laundry cleaning composition.

16. A method of treating a surface, comprising (i) forming an aqueous wash liquor comprising: (i) a DNase having at least 60% sequence identity to the DNase shown in SEQ ID NO: 1; (ii) at least one additional enzyme selected from the group consisting of amylases, cellulases, lipases, mannanases, proteases and mixtures thereof; and cleaning adjunct; and water,
(ii) treating the surface with the aqueous wash liquor at a temperature of from 10 to 40° C.; and
(iii) rinsing the surface.
